(19) United States
(12) Patent Application Publication
(10) Pub. No.: US 2002/0103660 A1
(43) Pub. Date: Aug. 1, 2002

(54) Generic transaction server

(76) Inventors: Kurt Cramon, Horsholm (DK); Peter Glaesel, Allerod (DK); Ole Holmskov, Hillerod (DK); Sune Aggergaarg Mortensen, Copenhagen (DK)

Correspondence Address: BIRCH STEWART KOLASCH & BIRCH, PO BOX 747, FALLS CHURCH, VA, 22040-0747, US

(21) Appl. No.: 09/996,583

(22) Filed: Nov. 30, 2001

Related U.S. Application Data
(60) Provisional application No. 60/253,929, filed on Nov. 30, 2000.

(30) Foreign Application Priority Data
Nov. 30, 2000 (DK) PA 2000 01802

(51) Int. Cl. G06F 15/163; G06F 17/60

(52) U.S. Cl. 705/1

(57) ABSTRACT

The present invention relates in a broad aspect to a method for conducting electronic transactions based on business processes, also known as e-Business, by the use of software. By providing a central configuration tool, the invention enables an automatic generation of a central transaction kernel used to integrate all business processes and further integrate to external systems. Thereby, a routing on business process level is obtained. The present invention is particularly useful for e-Business, but it is relevant for all areas of electronic transaction based processes. Also, a synchronous to asynchronous mechanism is introduced that allows plug-in of different communication and formatting components.

The present invention relates in broad aspect to a method for conduction electronic transaction based business processes also known as e-business by the use of software. By providing a central configuration tool, the invention enables an automatic generation of a central transaction kernel used to integrate all business processes and further integrate to external systems. Thereby a routing on business process level is obtained. The present invention is particular useful for e-Business but it is relevant for all areas of electronic transaction based processes.

Also, a synchronous to asynchronous mechanism is introduced that allows plug-in of different communication and formatting components

### BACKGROUND OF THE INVENTION

Today when you want to set up a complete e-business solution, you will need different vendors in order to cover the most basic needs (In the following, companies that want to set up an e-Business solution is referred to as “Merchants”): Shop, credit card clearance, ERP system, CRM, BI, physical order fulfillment. As a consequence, the business data is segmented into different systems using different interfaces and database technologies. Therefore it is very difficult or even impossible to obtain a “real-time” overview of the total amount of data, and as a consequence the Merchant will not be able to provide an optimal service for the customers. Further more, it will be very hard to obtain any interaction between the different data segments in terms of Business Intelligence and similar. To exemplify the different challenges a Merchant faces when implementing an e-Business solution, two scenarios are described:

The first scenario is a “new dot-com”. This Merchant does not have any IT infrastructure to support their business processes to begin with, and therefore he purchase a solution from some kind of consulting company or Value Added Reseller. The Merchant typically chooses to outsource his fulfillment to his suppliers and/or to 3rd party fulfillment providers.

The second scenario is a ‘bricks and mortar’ company, that has an existing IT infrastructure supporting its non-web processes, however the new sales channel—the web means that they need not only a web-shop which is somehow integrated to their back-end systems (preferable as a system to system integration), but also new partners and business processes (new sales channel). An example of this is a manufacturer who traditionally has traded exclusively using distributors and retailers, but now wants to start selling some of his products directly to the end customers, thereby becoming a Merchant in our terms. Since these orders are typically a small quantity per order line (as opposed to the traditional process where the manufacturer ship whole pallets of a product to distributors), desires to use a 3rd party fulfillment center that is optimized for this kind of business process.

In both scenarios, the Merchant will typically not have in-house either the total set of business skills or the IT skills to perform the task of defining and implementing the solution. Also, they are typically under some pressure from financiers or competitors to get the solution up-and-running quickly.

Therefore, in most cases, they will seek out a consulting company or a Value Added Reseller whom they sign up to deliver their solution.

The phases of such a project then typically includes: Strategy, solution design, hardware selection and software products, set-up and systems integration and tests.

Please note that for the ‘new dot-com’, it is necessary to identify software products that preferably cover: Web-shop (with content management tool), CRM, Business Intelligence, ERP (with ledger, account/receivable, account/payable, inventory management, purchasing, invoicing) and not least integration with partners (e.g. fulfillment), banks and payment gateways. Additionally, the Merchant (at least outside the US) need to find solutions for international trade (how to optimize their business structure and placement), how to calculate VAT, Tax and Duty, due to international invoicing, etc.

Because of the relative high cost of consultants and not least the time-pressure, the Merchants typically chooses a limited scope for the solution as opposed to what they really need. For instance, most Web-shops in the world have initially been set-up using manual integration into back-end systems. This increases the cost of operations significantly, plus introduces errors and directly impacts customer satisfaction. Other typical shortcuts include starting out without a targeted marketing capability (at best they can send everyone the same e-mail), lack of Business Intelligence meaning that they really do not know how to optimize their business, and that the ad-hoc manual processing introduces errors in their financial system (or that they lack sufficient detail) so that they do not have an overview of their financial situation.

Additionally, the solutions tend to be less flexible, i.e. it takes a lot of time and money to change the business model, add new fulfillment partners or other services.

Finally, today the customers expect high performance Web shops regarding responsiveness, availability and capacity. To achieve this, the IT consulting company or Value Added Reseller must design a hardware/network/software infrastructure that is scalable, reliable and fast. The skilled resources that makes this possible are limited in numbers and in great demand on the marker and therefore the typical solutions today are of less quality than desired by the Merchant.

Today when changing/adding new business processes to a transaction kernel and database APIs human interaction is needed to implement this manually and thereby changing core components. This is a substantial source to errors.

When adding new Services into a transaction kernel human interaction is needed. As before, this is considered to be a substantial source to errors.

The Integration between different external and internal systems is difficult to obtain due to the variety of protocols and data structure formats. Also the need for synchronous-to-asynchronous communication is a challenge.

Transaction systems are normally very closed in their architecture and difficult to integrate into from external systems.

By conducting online business reporting on a transaction database there is a great risk of resource violation and a consequence is poor performance and in worst case errors and lost business transactions is the result.

When adding new data elements and services to a transaction kernel, the transaction database needs to adopt these changes to the business data set in order to reflect the business. Again such changes are implemented by human hand and thereby a substantial risk of errors is introduced.

### BRIEF DISCLOSURE OF THE INVENTION

According to the objects of the present invention, the invention relates in a first aspect to a method of configuring a generic transaction server comprising a transaction kernel being specific for the server and has a plurality of configured services assigned, such as linked, said generic transaction server being useful for performing transactions on a computer system. In accordance with this aspect the method may preferably comprise the steps of:

selecting and/or adding a number of services, said selection being preferably based on a business model, each service being adapted to communicate with a transaction kernel by keyword/value pairs; each keyword/value pair is either input, output and/or internal;

configuring some or all of the services selected, said configuration being preferably performed in such a manner so that the configured services are reflecting the business model;

if necessary or desired generating a business configuration database defining the configured services related to the business model; and

building a transaction kernel of the generic transaction server, said transaction kernel being adapted to inserting, hashing and fetching keyword/value pairs from and routing keyword/value pairs between services linked to the transaction kernel, said inserting, fetching and routing being instantiated by receipt of a transactions string.

The generic transaction server is, thus, an instance resulting from a configuration of selected services and building of the transaction server. However, as the transaction server provided is, preferably, reflecting the whole underlying business model considered and thereby has the potential to meet the demands of the business model, preferably without the need for extra functionality, the transaction server is termed generic in the sense that the transaction server is generic for the business model. Therefore, the term generic used in “generic transaction server” should not be confused with general, in the sense not being build for any specific for any specific purpose.

The method of configuring a generic transaction server is applicable in at least the following two cases

i) no generic transaction server has been made previous

ii) a generic transaction server has been made previous and some additional services are added to the server.

In case i) services will preferably be selected whereas case ii) preferably results in that one or more service or keywords are added to the existing configuration. In cases of adding services to the existing configuration, previous selected services do not necessarily need to be selected once again. Information about such previous selected services is preferably stored in a storage means, such as a file, and once a new instance of the generic transaction server is to be build, the information about the previous selected services is retrieved from the storage means and used during building of the transaction server instance. Thus, a new instance of the generic transaction server is preferably build when services are added and/or selected.

Building of the kernel of the transaction server is preferably performed by use of a code generator which generates the code of the trasaction kernel based on the selected and/or added services. In preferred embodiments, the code generator utilises information on the selected and/or added services stored in storage means, such as one or more file—this information preferably constitute the configuration. Preferably, the information comprises the keyword/value pairs of all the services of the configuration, and the code generator reads this information and builds the transaction kernel based on this information.

Thus, in order to fulfill the “mission goal” a transaction server is defined. The model is the framework that the business processes and data must be defined within. The service comprises mainly five entities: Instance (or version), Service, Keyword, Keyword in Service and Section.

According to the first aspect of the present invention selection and/or adding a number of services are performed. These selected services comprise the functionality needed in the generic transaction server to perform transactions needed according to the business model.

In general, business models require some kind of universal functionality and some kind of configurable functionality. Accordingly, the services selected and/or added is preferably selected from a group of services comprising services to be configured so as to reflect the actual business model and comprising services containing universal functionality which not necessarily needs configuration.

A common feature of the services is that these are adapted to communicate with a transaction kernel by keyword/value pairs. This is an extremely important feature in the sense that for instance:

the transaction kernel does not necessarily need be able to treat or know the properties of the values of the keyword/values pairs, the transaction kernel does only need to know that a value exists.

a de-coupling between the transaction kernel and a transaction database is obtainable, that is the transaction kernel may store keyword/values pairs in the transaction database without any restriction with respect to properties, types, values or the like of the keyword and values stored but still being able to “decode” the information of the keywords and values using the same rules as the transaction kernel and services.

keyword/values pairs can be treated in a generic way.

It may be useful for further expansion, e.g. addition of further services, to generate business configuration database defining the configured service(s) related to the business model. If such a database is generated, easy expansion of the generic transaction server is provided as the configuration of the old services needs not to be specified but may be extracted from the database.

After or during selection and/or addition, configuring of services and generation of the business configuration database a transaction kernel is generated. The role of the transaction kernel is to insert and fetching keyword/value pairs and routing keyword/value pairs between services linked to the kernel, which will enable execution of a request for a transaction instantiated by receipt of a transaction string.

In very important embodiments of the method according to the present invention, the method comprises the step of building a hashing formation, such as a vector, matrix or the like. Even though, building of the hashing formation is addressed in connection with the method of configuring a generic transaction server, it is contemplated that the hashing formation building may be a second separate aspect of the present invention which is applicable in connection with any method needing or requiring parsing of a data string, preferably being character based, comprising at least one keyword/value pair.

The method of building a hashing formation comprises preferably the steps of:

providing a predefined hashing formation, such as a vector, matrix or the like, in which each predefined combination of a selection of characters is represented by a unique element, said selection of characters being preferably all those characters or substantially all those characters being allowed to figure in said keywords; and

for each keyword to be supported by the kernel, assigning a first pointer to the element representing the combination of characters representing the keyword in question, which first pointer is pointing to said keyword.

Furthermore, parsing of reserved keywords may preferably be based on a separate hashing formation and in accordance with the present invention the method may preferably comprise the steps of building a separate hashing formation, such as a vector, matrix or the like, for parsing reserved keyword/value pair, said reserved keyword/values pairs stipulates for instance services to be requested, priority of execution service, host on which the service is to be executed etc.

According to a third aspect of the present invention a generic transaction server has been provided. The generic transaction server comprises a transaction kernel having a plurality of configured services assigned, such as linked, and

said services communicates with the transaction kernel by keyword/value pairs; each keyword/value pair is either input, output or internal;

said transaction kernel being adapted to inserting and fetching keywords from services assigned, such as linked, to the transaction kernel and wherein

communication to and from the transaction kernel is preferably provided by a Server entry point.

The transaction kernel further is preferably also adapted to routing keywords between said services.

Enabling of routing, inserting and fetching of keywords by the generic transaction server may preferably be provided by use of a hashing formation, such as a vector, matrix or the like, for parsing elements of a data string, preferably being character based, comprising at least one keyword/value pair, which hashing formation is preferably considered a part of the transaction kernel.

Again, such a hashing formation is contemplated as a separate aspect of the present invention which formation is applicable in all situations where parsing is needed or requested.

The hashing formation comprises preferably

a plurality of pointers to pointers entities; wherein each of the pointer to pointer entities comprises a first pointer pointing at either directly or indirectly at least one second pointer configurable to pointing at at least one of the elements of the data string or being null-terminated, such as pointing at a null-pointer; and

an entry to each first pointer.

Preferably, an element may be a keyword, a value and/or a keyword/value pair comprised in the data string.

It is preferred that each entry to each first pointer is indexed and accessible by a selected number of characters of the keyword corresponding to second pointer. In preferred embodiments of the invention the selected numbers of characters are the first and the last character of said keyword corresponding to said second pointer.

Also in this aspect of the invention a separate hashing formation may be useful and it is preferred in such cases that the generic transaction server comprises a separate hashing formation for parsing reserved keyword/value pair. The reserved keyword/values pairs stipulates for instance services to be requested, priority of execution service, host on which the service is to be executed etc.

In typical preferred embodiments of the present invention the separate hashing formation comprises entries, wherein each entry corresponds to a reserved keyword and wherein each entry having assigned to it a pointer pointing at the functionality corresponding to said reserved keyword.

Definitions and explanations relevant to some of the terms used in the present specification and claims are as follows:

Service: A single business process that can be defined as having a set of input and output parameters and by operation on the input parameters, using predefined business rules, the output parameters is a unique result there of. An example could be the calculation of currency exchange, credit card clearance, processing of a WAP message etc.

Transaction: A transaction is a single request for a specific service, using the transaction kernel as router, and the Service returning the resulting output. Input and Output parameters are represented in an internal format.

Transaction Kernel: The transaction kernel is the entity that integrates first of all the Services but also brings integration to other systems. It also holds the central parsing and hashing implementation.

Client: All entities that request the Transaction Kernel for Services are called clients. This could be a WAP telephone, Web shop, etc.

Interface Server: A Server that provides a synchronous-to-asynchronous communication and also bridges between different protocols.

System Manager: A number of applications that monitors, manages and tune the overall performance, capacity and availability for the system.

ERP: Enterprise Resource Planning.

CRM: Customer Relation Management

BI: Business Intelligence

ASP: Application Service Provider

VIDELITY: Is the a designation of preferred embodiments of the present invention

Keyword/value: To describe the Attributes of Business entities a Keyword Value definition is used. As an example: The Customer Entity contains the Attribute “Customer First Name” and that will then be the Keyword. The Value of this specific Keyword “Customer First Name” can for example have the Value “Bob”—thus “Customer First Name”=“Bob”

Business Model: Is a description of a specific Business process and datamodel from which Business entities and attributes can be deducted from. It will also reflect the Business requirements to a given system.

A transaction kernel generated in accordance with the present invention has a number of advantages, whereof some of these are pronounced in the following.

By generating a transaction kernel that is optimized precisely for a specific Merchant's business processes and requirements, a high performance and no overhead in carrying extra data or business logic is obtained.

By introducing a new method for parsing a keyword/value pair based data-structure, by hashing into a matrix and further mapping the elements to a data structure, a very fast insert and fetch parsing method is obtained.

All data are collected and stored in one database, and thereby an easy access from other systems to the business data is provided.

By collecting business process configuration data and business model configuration in one place (the configuration database) the invention makes it possible to conduct generation of the transaction kernel, transaction services and business configuration of the pre-burned services, all in one step.

In another aspect, the present invention relates to a computer system, which preferably comprises a transaction server according to the present invention and an interface server according to the present invention. The interface server preferably supports asynchronous to synchronous transactions sequences of the computer system and comprises

a set of interface functions for accessing services being external to the transaction server,

one or more connections each connecting a service of the transaction server to the interface server enabling data communication from services of the transaction server and to the interface server, and

a connection between one or more of the interface server's interfaces and a Server entry point of the transaction server.

With such a system a service of the transaction server may be able to complete its service without awaiting finalizing of data processing performed by services being external to the transaction server as execution of such data processing is taken care of by the interface server which, when the data processing is finalized, enters the result thereof to the transaction server through the transaction server's entry point.

Preferably, the computer system according to the present invention preferably further comprising a scheduler for controlling accessing of the services being external to the transaction server.

Furthermore, the computer system according to the present invention may advantageously also comprise storage means for storing and retrieving data to be processed by the one or more external services, and wherein one or more of the interface functions being adapted to store and retrieve data to be processed by the one or more external services.

Thereby, the computer system may be able to bundle data of for instance similar kind requiring similar processing whereby such a bundle of data may be routed to one or more external service for processing. After processing the computer system may be able to store the result of the processed data and communicate the data in a step wise manner to the transaction server.

Furthermore, the storage means is/are also advantageously in situations where the processing of data by external services is not available due to for instance malfunctioning of an external service. In such and other scenarios, the interface server can store data to be processed and await a scenario where the external service(s) is(are) available.

Storing and/or retrieving is preferably controlled by the scheduler.

The configuration also makes it possible to have each Merchant's configuration in our database—enhancing the possibilities of support.

The present invention makes use of and is embodied by a computer system comprising storage means for storing data and processor means for processing instruction and data.

### DETAILED DECRIPTION OF PREFERRED EMBODIMENTS OF THE INVENTION

The invention will now be described by way of examples. The description firstly focuses on a specific embodiment of the invention, which embodiment relates to an e-business transaction system. Secondly, the description focuses on the transaction kernel being a part of the transaction system.

The invention and the preferred embodiments thereof is described in connection with the accompanying figures in which:

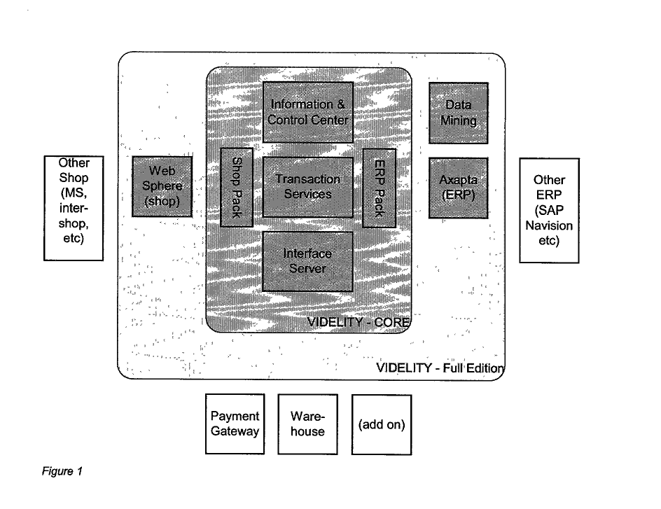

FIG. 1 shows VIDELITY components

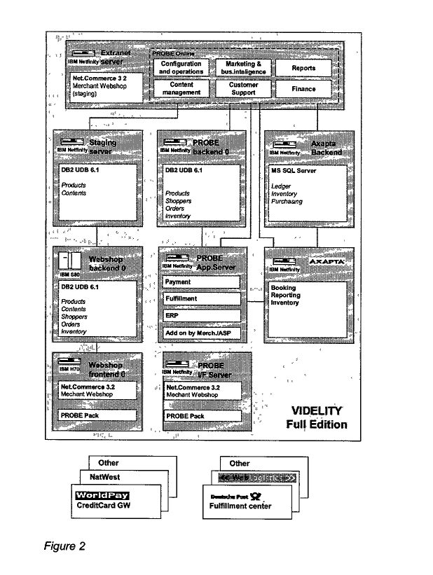

FIG. 2 shows VIDELITY full edition

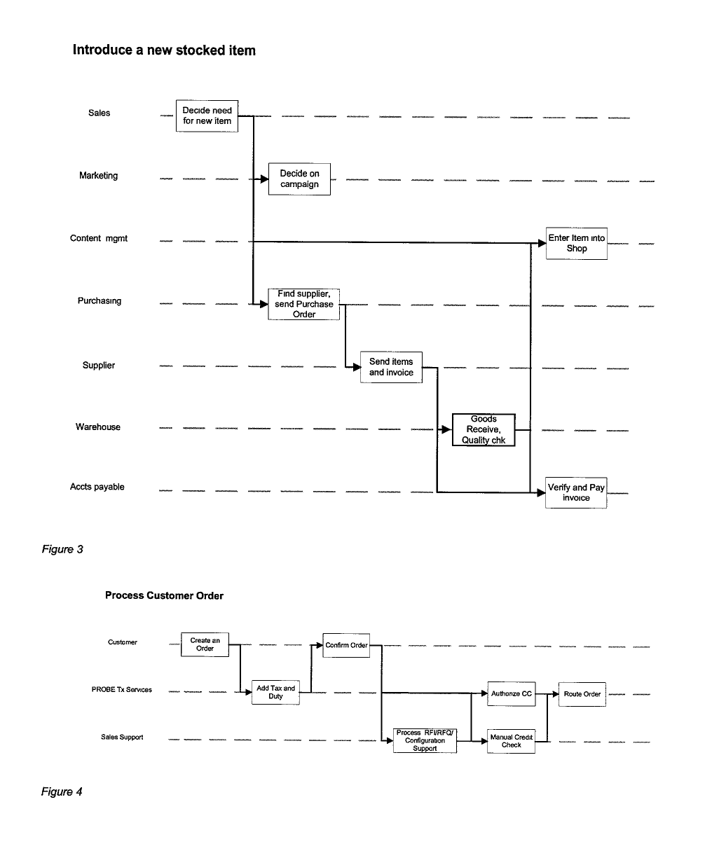

FIG. 3 shows process for new stock item

FIG. 4 shows process for customer order

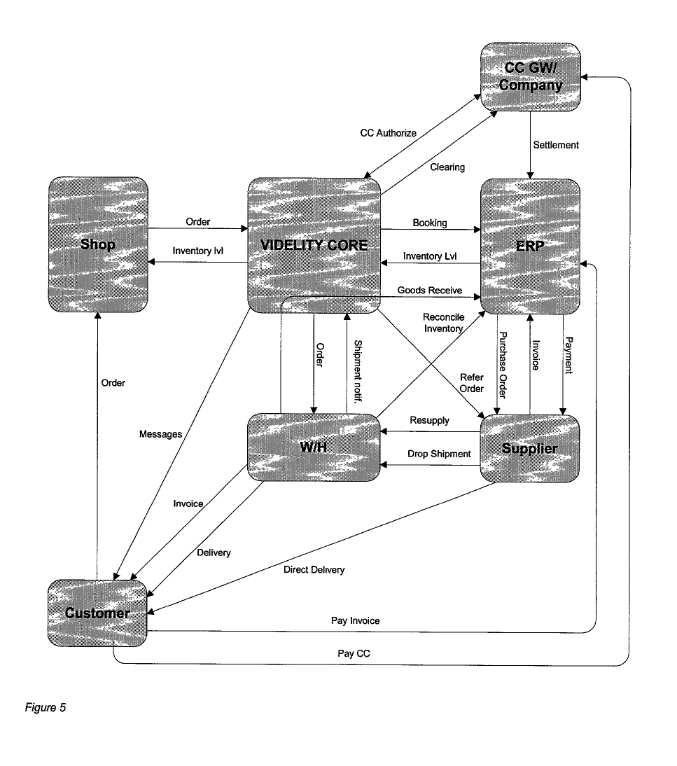

FIG. 5 shows flow for 3.rd party fulfillment

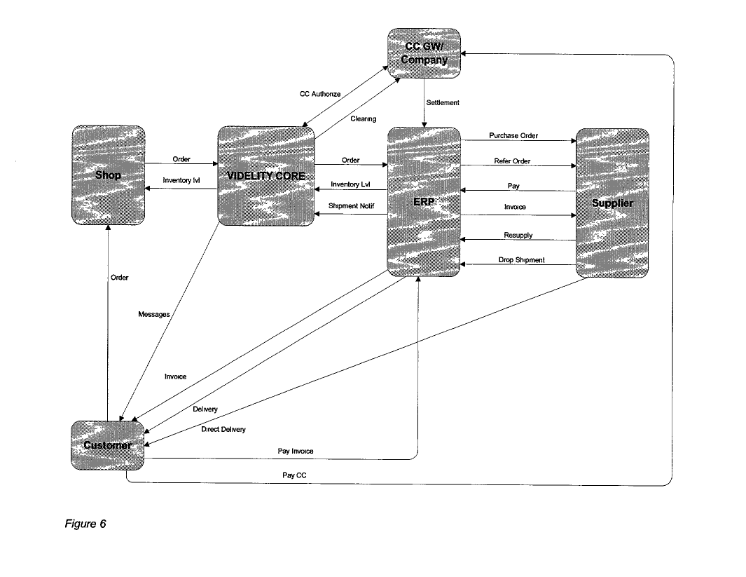

FIG. 6 shows flow for inhouse fulfillment

FIG. 7 shows process flow for 3.rd party fulfillment

FIG. 8 shows process overview

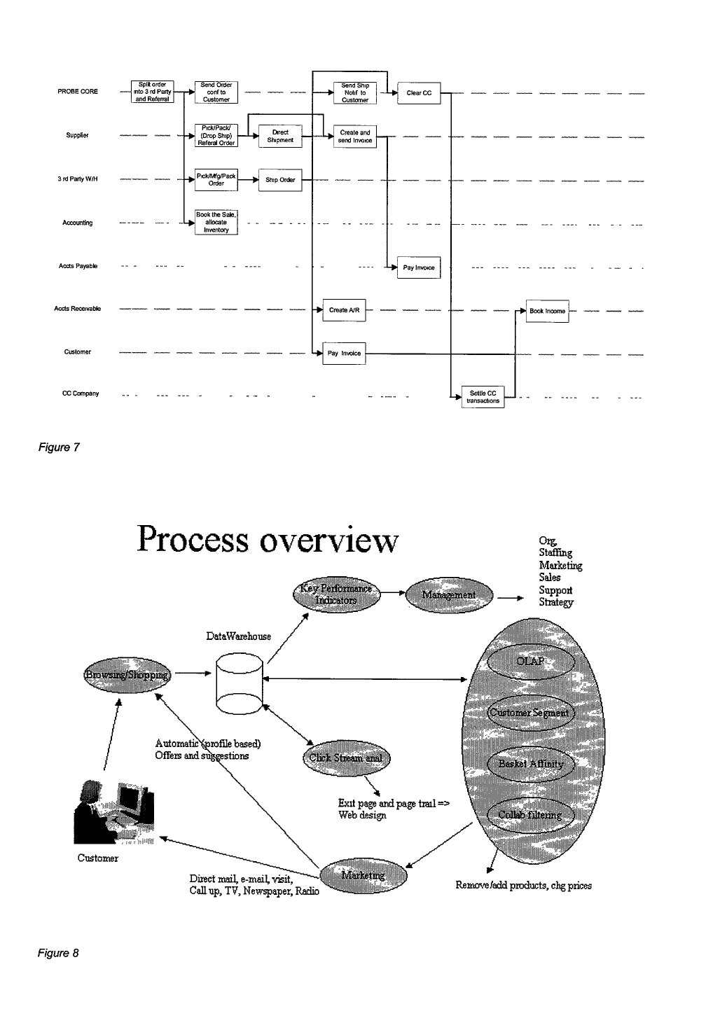

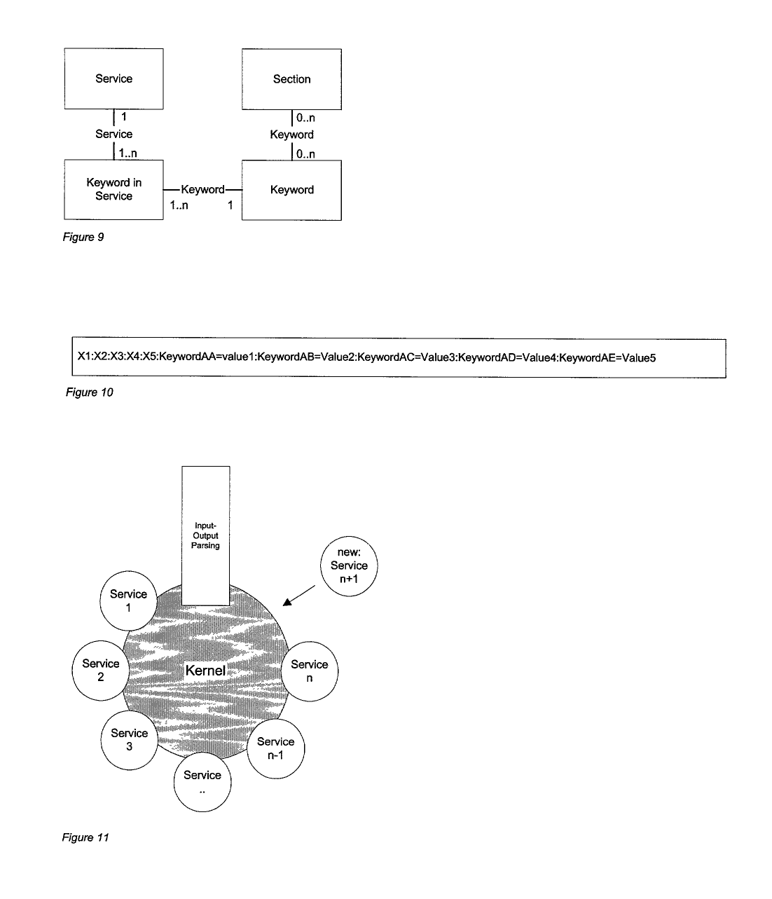

FIG. 9 shows transaction model

FIG. 10 shows the definition of the Transaction protocol used to communicate between clients and Server

FIG. 11 shows model of Service and Transaction Kernel

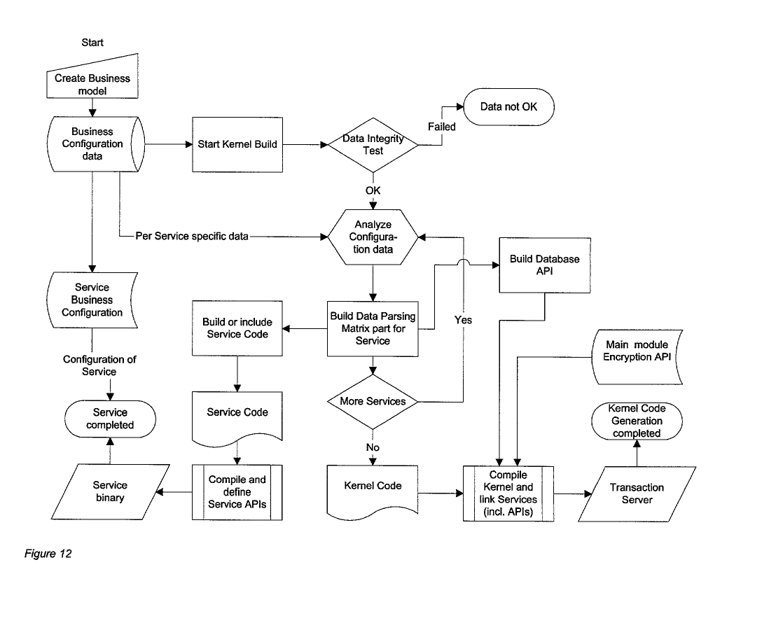

FIG. 12 shows kernel and Service build process

FIG. 13 shows hashing and parsing matrix

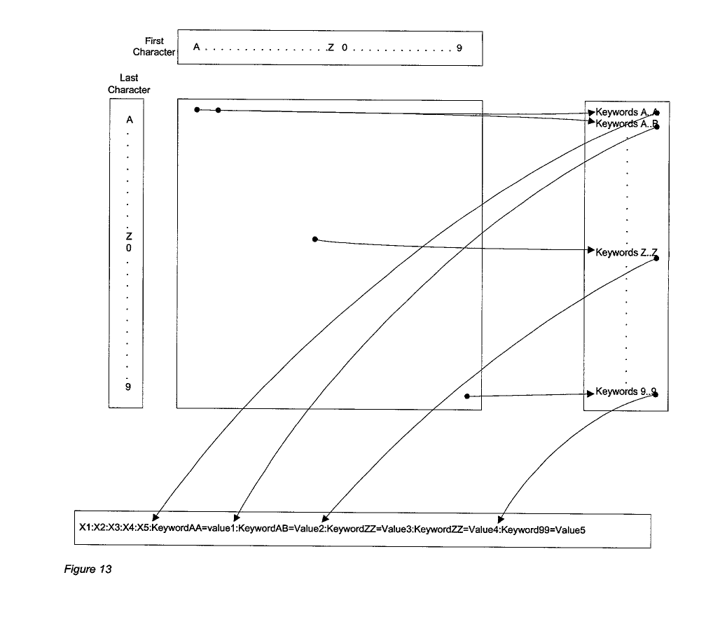

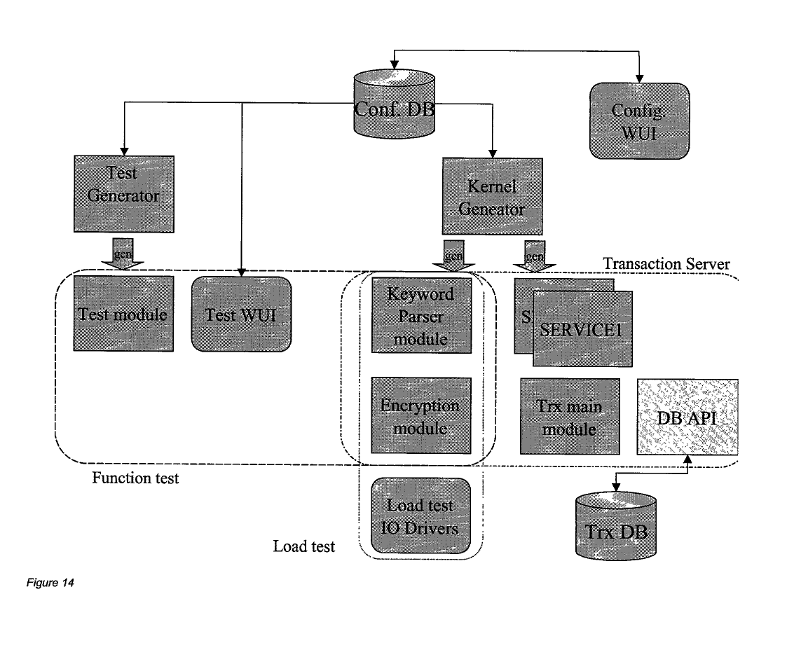

FIG. 14 shows components for configuring and building the kernel

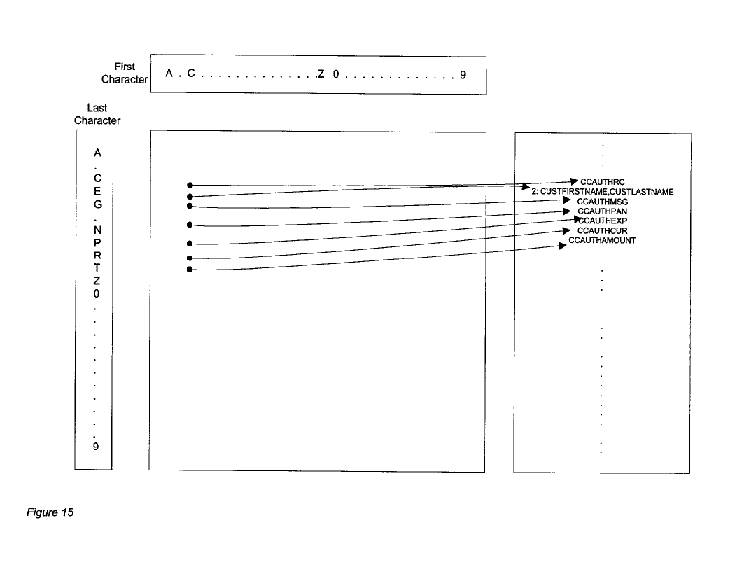

FIG. 15 shows example of keyword matrix mapping

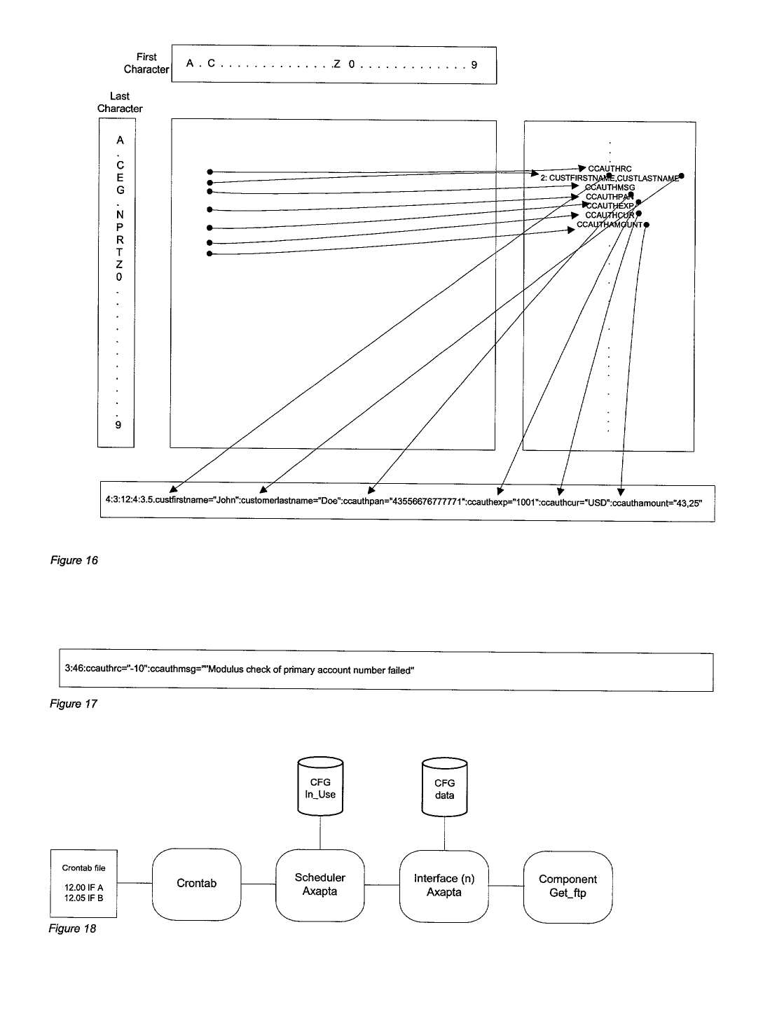

FIG. 16 shows hashing and parsing of an incoming transaction request data-string

FIG. 17 shows example of response data-string from the ccauth service

FIG. 18 shows interface start and configuration

FIG. 19 shows case of error reading configuration (CFG) data

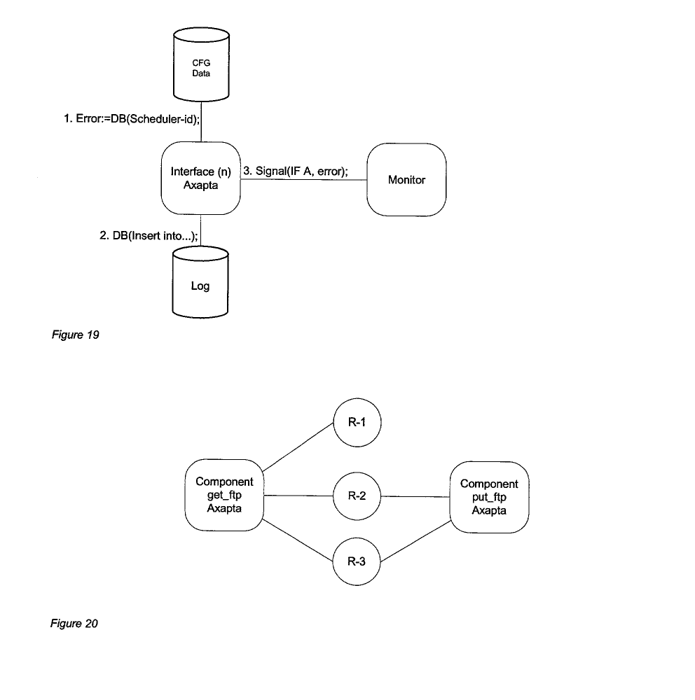

FIG. 20 shows resource allocation of a specific component

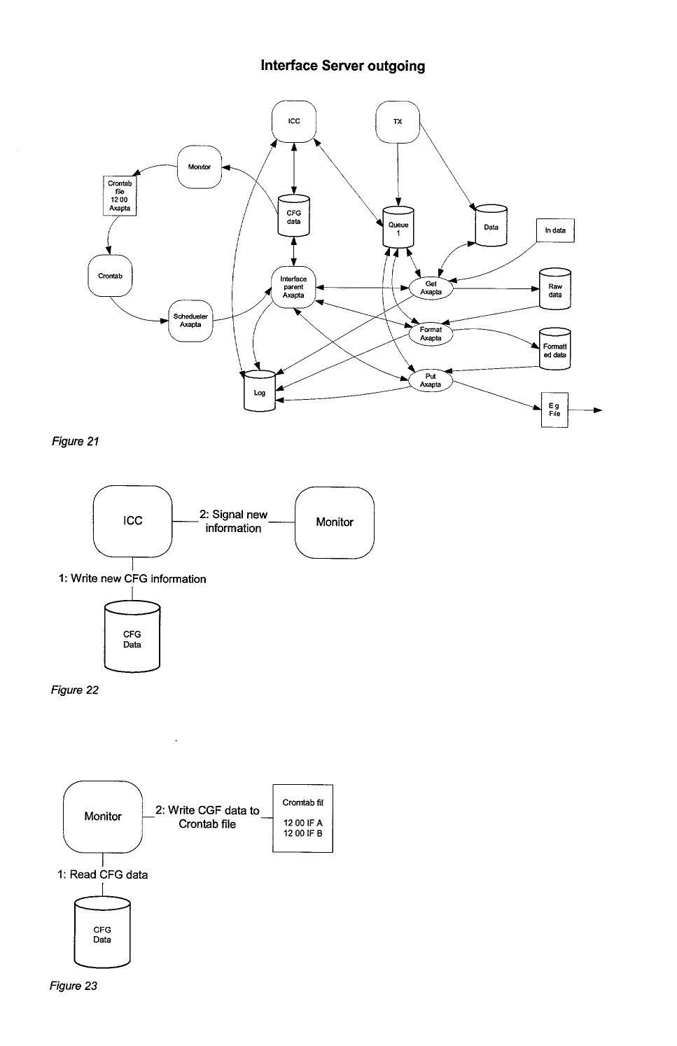

FIG. 21 shows outgoing flow of the Interface Server

FIG. 22 shows monitor process for the interface server

FIG. 23 shows integration with the OS (UNIX) crontab

FIG. 24 shows start of scheduler

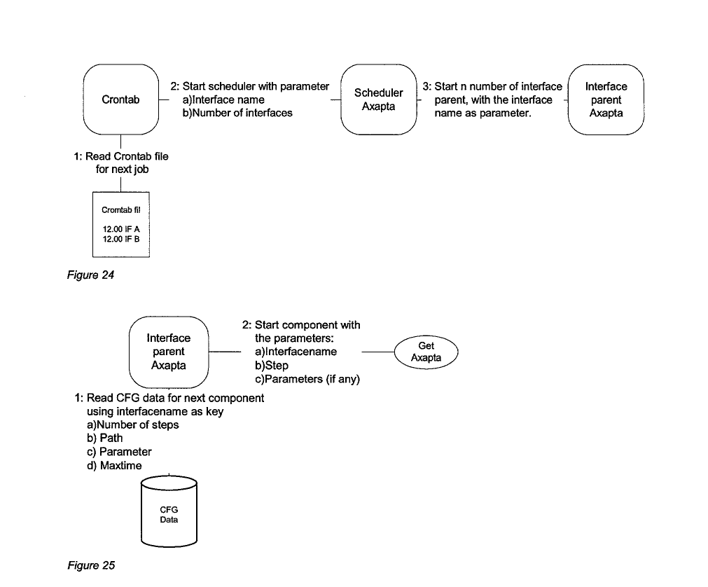

FIG. 25 shows start of component

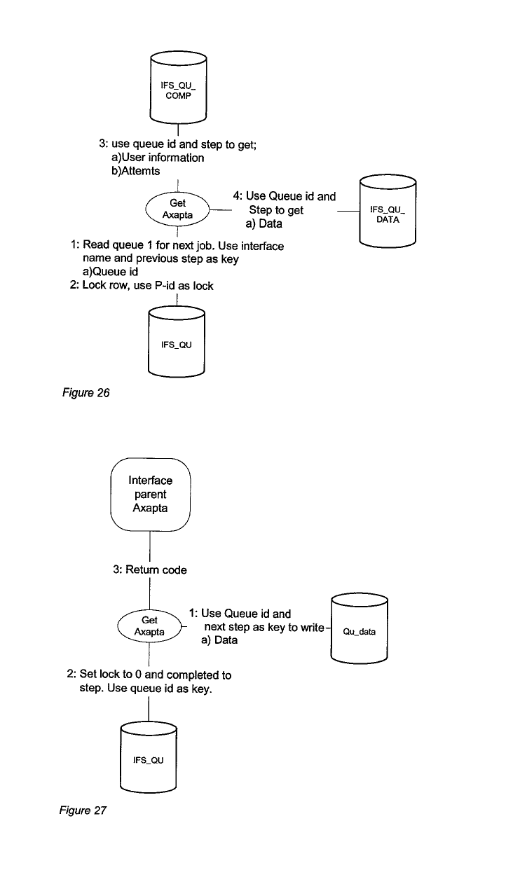

FIG. 26 shows component processes busisness data

FIG. 27 shows storing and exiting from component—work done

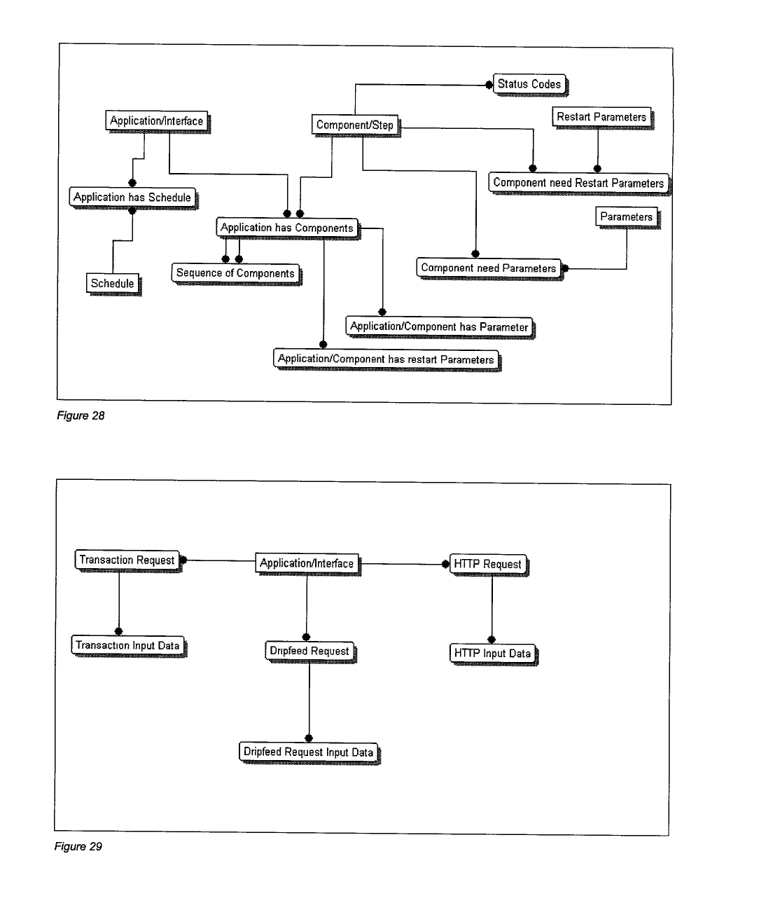

FIG. 28 shows datamodel for the component setup

FIG. 29 shows datamodel for a interface request

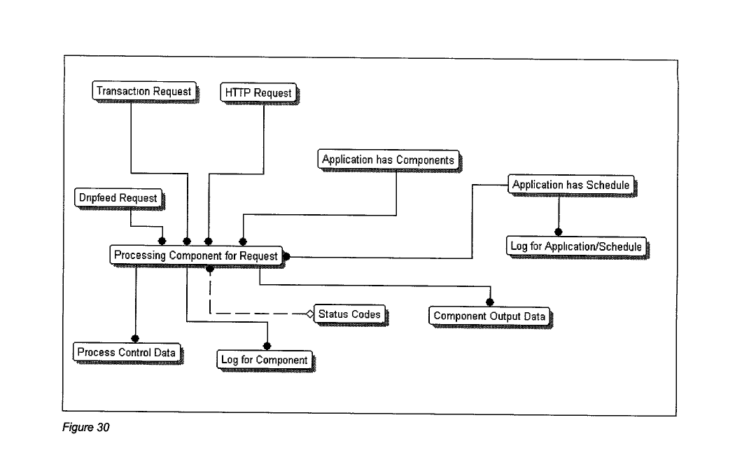

FIG. 30 shows data model for the processing part of the Interface Server

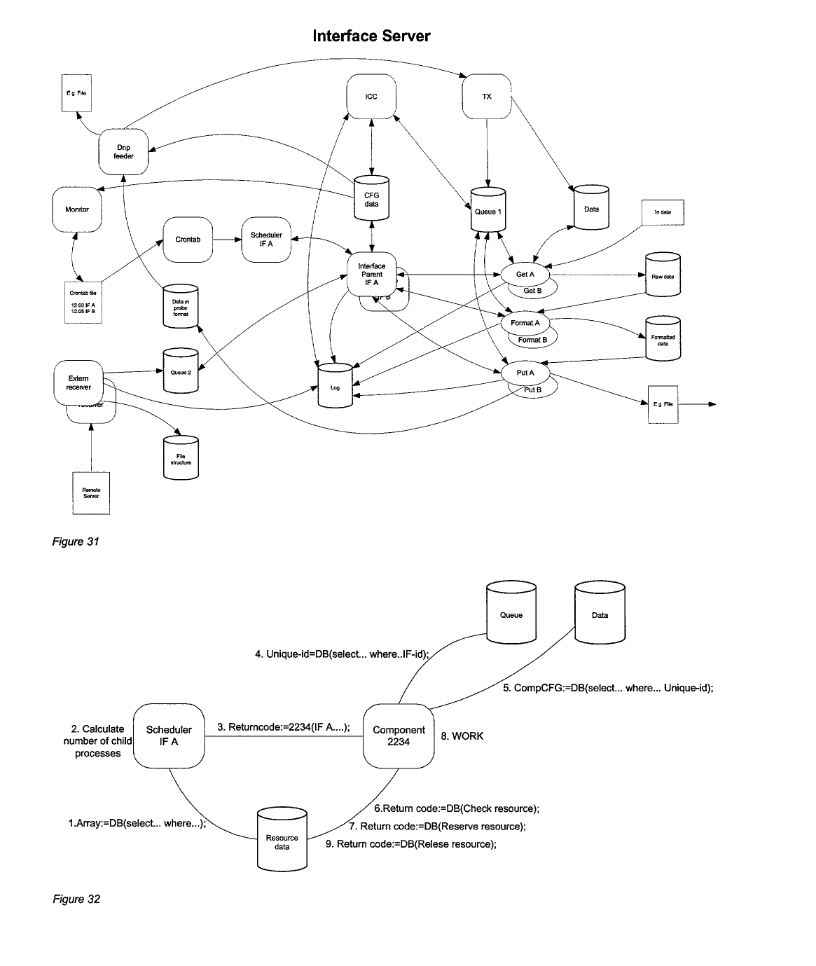

FIG. 31 shows total flow model for the Interface Server

FIG. 32 shows resource handling. Notice the order of Operation (1)

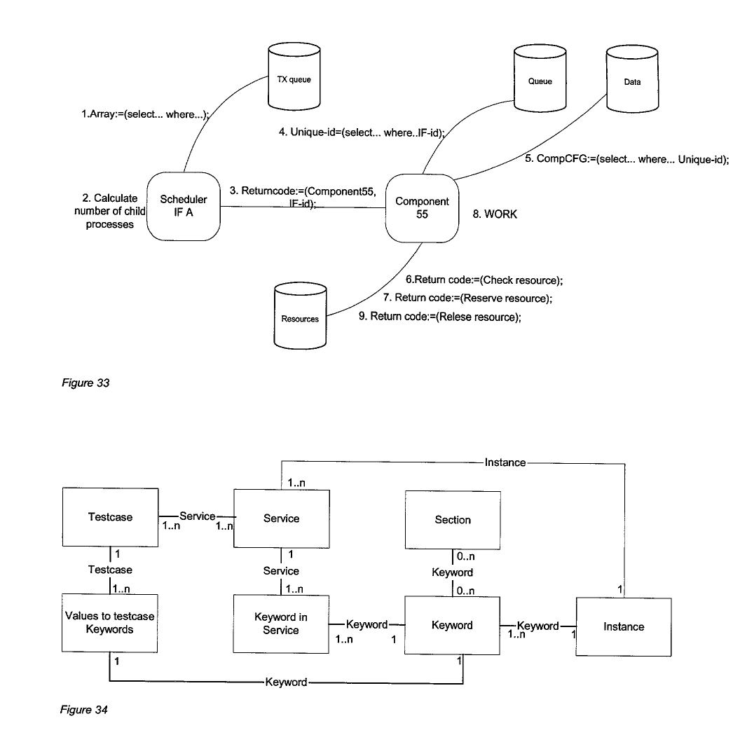

FIG. 33 shows resource handling. Notice the order of Operation (2)

FIG. 34 shows more detailed version of FIG. 9

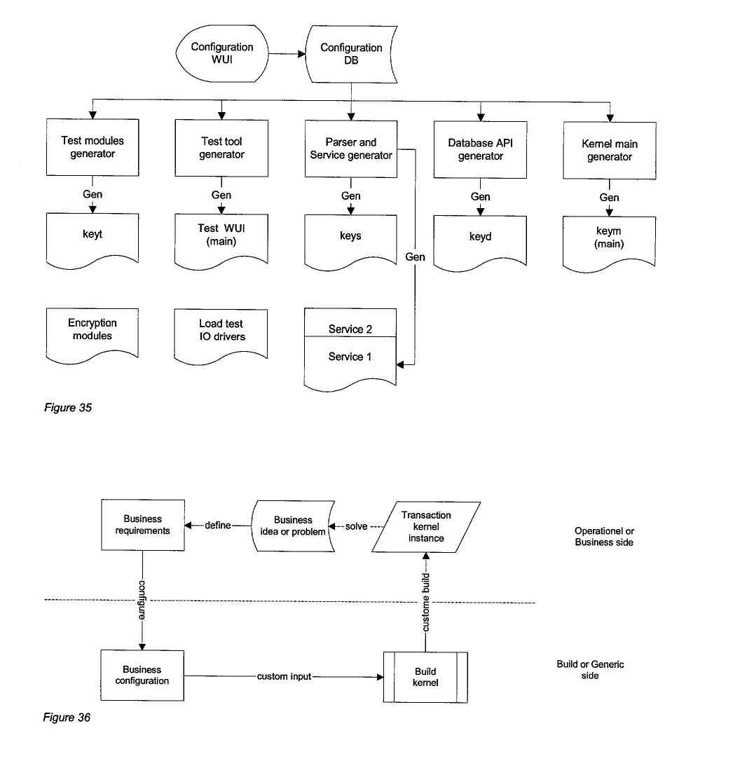

FIG. 35 shows more detailed version of FIG. 14 and

FIG. 36 shows in order to diffirentiate between the build and the Transaction Server instance part.

### GENERAL OVERVIEW OF A PREFERRED EMBODIMENT OF THE INVENTION

The present invention relates in a preferred embodiment to a unique entity of hosted, web-based enabling services to facilitate a complete, ready-to-run e-business infrastructure for both dot-com start-ups and traditional Bricks and Mortar companies with e-business projects (hereafter called Merchants).

The present preferred embodiment provides the following features:

Delivery of a complete software infrastructure for newco's, bricks&mortar and ASP's that want to do e-business

This infrastructure will encompass selected best of breed Web shop, Business Intelligence and ERP applications, and supply its own Content Management, CRM, payment processing and Order Management

Global scope, localized appearance and functions

Addressing both B2B and B2C

Highly flexible solution, with emphasize on ease of system integrations

The features have been provided by a system exemplified in the FIG. 1 depicting the preferred embodiment of the invention designated VIDELITY.

The Shop can either be IBM's WebSphere Commerce Server, and thereby part of a pre-integrated VIDELITY environment, or any other Web/WAP/Palm shop the Merchant or ASP may choose. VIDELITY provides a comprehensive set of processes and services to the Shop, such as Content management, Logistics, VAT/TAX, Duty, Payment, etc.

The Information and Control Center is a web based tool for the ASP and/or Merchants to manage the application and the business. It includes Content Management, CRM, Finance, Configuration and Operations.

The Transaction Services engine comes with a set of standard services, and is designed to facilitate any new service the ASP and/or Merchant may need (e.g. access to contracts) The Interface Server has a set of interfaces to e.g. payment gateways and warehouses, and is designed openly to facilitate any new interfaces the ASP and/or Merchant may need.

VIDELITY Full Edition comprises preferably an open interface for Business Intelligence Tools, and Axapta as the ERP system for Inventory Level Management, Purchasing, Accounts Receivable, Accounts Payable, Accounting, HRM and Facility Management. However, the ERP Pack can connect to any other ERP system, and VIDELITY is flexible in that the Merchant may chose which functions he need from VIDELITY, and which he does in his ERP system. For instance, some Brick and Mortar companies may prefer to handle the logistics in-house (using their existing ERP system), where as most new dot COM companies prefer to use 3.rd party fulfillment.

The services and processes offered by VIDELITY Full Edition comprises preferably:

Web shop

Content Management

Create and maintain items in the catalogue, with categories and pictures

Import items from the ERP

Mass generate prices to country prices, with VAT, currency conversion etc

ERP, with

HR

Accounting

Inventory Level Management

Purchasing

Accounts Receivable and Payable

Payment Processing

TAX/VAT Calculations

Duty Calculations

Business Model Compliance

International Invoicing

Multi-currency

Multi-country pricing

National Language Versions

Logistic Handling, inbound and outbound

Internet access for Merchants and ASP

Customer Relationship Management

Business Intelligence

Web enabled

Add-on Service configurator

Interface Management

Configuration

Operation

Tailoring of reports

Look and Feel

The VIDELITY Architecture has the potential to bind all the building blocks together. This means that a Merchant can purchase any number of the service building blocks, since all might not be needed. Some Merchants might e.g. have own logistics systems from existing distribution centers, but no web shop services or TAX/VAT calculations. Through the open architecture interfaces, the Merchant can connect these own logistics systems to the VIDELITY building blocks to gain access to web shop services and TAX/VAT calculations.

As indicated in FIG. 1 Videlity—Full Edition comprises preferably a number of business components and the contents and purposes thereof will be put forward in the following sections

Information and Control Center

The “Information and Control Center” is the user interface to VIDELITY, for the ASP, VAR and/or Merchant.

It has a configurable look and feel, that is:

He can insert his logo and set the background color on all screens etc.

Each user can decide which language he prefers, from a list of languages (such as English, German, French, Italian, Danish, Swedish etc).

Similarly, the user can define the Time zone in which he wants to see time values, both online and in reports.

The application is able to display text information (such as customer name and address) in all Latin characters, plus double byte character set. The access to data and functions is controlled with user id/password, associated to a user profile. This ensure that a Merchant can enforce separation of duties, and that one Merchant is unable to get access to another Merchants data, even if they may share the same infrastructure at an ASP.

The Information & Control Center preferably comprises the following major parts:

Configuration & Operations

Content Management

Marketing

Customer Support

Logistics

Finance

Reports

Business Intelligence

the contents and purposes thereof are put forward in the following.

Configuration & Operations

Configuration & Operations handles preferably:

Configuration and maintenance of Merchant data, such as his business model, Vat registrations etc.

Configuration of new Transaction Services: new data structures etc

Maintenance of User ID's, passwords, user profiles and access rights.

Access to system level information, availability, alerts, performance statistics etc.

Content Management

Content Management handles preferably:

Creation of new items and categories in the catalogue, with all necessary information, bitmap files etc.

Importation of catalogue information, e.g. from an ERP system.

Mass-generation of country prices, based on base prices. The computed prices will be rounded nicely according to configurable rounding rules, and will include: applicable vat, converted currency, uplift, duty (if applicable).

If a staging server is used, the Merchant can test the Shop and the catalogue information before propagating it to production. Otherwise, the changes will be made directly into the production shop.

Marketing

Marketing is capable of handling Push Campaigns, subscription campaigns and a documentation repository.

With Push Campaigns Marketing can create Campaigns that address selected customers. For instance Marketing can:

Create a “Push” Campaign, being a means to select a set of the registered customers from the Shop (or from a list of prospects from elsewhere) which should either:

Receive an e-mail

Receive a letter

See a message if they happen to log on to the Shop in a defined period of time

Review the customer set

Release the Campaign

With Subscription Campaigns The Customer can register an interest in categories of information, such as product lines and Marketing can:

Pull reports on how many customers are interested in the different categories

Create a new campaign

Request automatic release of the Campaign, or process it as a Push Campaign

Marketing can build and maintain a structured documentation repository (in national languages), as a combination of web pages and multimedia files (such as Adobe Acrobat).

The customer can:

Jump to Documentation items from the catalogue pages, either from a category or from an item.

Search for information from the Shop (via keywords)

Find information via a structured information index

Customer Support

Customer Support handles preferably:

Search for an Order (and see both Customer and Order information)

Search for a Customer (and see his information and his orders)

Create or see a ‘ticket’—a text entered by Customer support as a registration of a complaint or follow-up action.

Change an Order

Create No-Charge orders (replacement orders) either identical to the original order, leave something out or add items (such as free gifts)

Create refunds (or requests for refunds, to be released by higher authority)

Create, maintain, and monitor the use of a “Frequently Asked Questions” web-utility, with national language support

Do manual credit check on “pay per invoice” orders

Receive and process “Request for Quote” orders

Receive and process “Request for Information/configuration support” requests

Logistics

Logistics handles preferably:

Goods receive. The warehouse can register receipt of goods, and check against the purchase order. This will release the payment of the invoice from the supplier.

Turn Around Time at warehouses

List overdue orders

Manual fulfillment

Finance

Finance handles preferably:

Sales reports (summary and detailed)

VAT reports (summary and detailed)

Sales tax reports (specific to US and Canada)

Intrastat reports (specific to the EU countries)

ASP and merchant can get information on Merchant fees to ASP, depending on a configurable price-model.

All reports have configurable layout and content.

Reports

In support of a wide range of needs to get insight into the Merchant business, the following reports are offered. All reports have configurable layout and content and comprises preferably:

List refund frequency per item, country and customer

Inventory Levels, which items need attention ref inventory and/or sales

Customer browsing—summary of uncompleted orders.

Business Intelligence

Business Intelligence handles preferably:

Maximization of profit by taking an interest in you're the Merchant's customers, sales and business process performance

No use unless acting on the information

VIDELITY has build-in Business Intelligence features, and ready-made processes to act:

Suggestion pack for the shop

Campaign management

VIDELITY comprises preferably an integrated business intelligence application, as part of the Information and Control Center. Typically available analyses are:

Key Performance Indicators—Your key measurements

Customer Segmentation—what kind of customers do you have

Basket affinity analysis—what is typically ordered together

Click stream analysis—insight into the browsing activity in the shop, what do they look at, from where do they leave, how do they get through the shop

Collaborative Filtering—buying patterns

Online Analytical Processing (OLAP)—A wealth of information to delve into, on orders, sales, customers

ERP Pack—a Service that Connects to an External Existing ERP System

This module being an example of a service enabling connection to external system and has the ability to connect to for instance Axapta (the standard ERP package with VIDELITY), and has preferably an implementation of XML for other ERP Packages.

Shop Pack—an External Client Pack that Enables Execution of Services using the Transaction Server Instance

This client pack enables a shop (such as Web Sphere Commerce Server) to communicate with the Transaction Services and feed non-order related information regularly to the Information and Control Center (such as customer browsing activity).

It also comprises in some situations an optional module for execution directly in the Shop environment: The Pricer module, calculating dynamically local prices, nicely rounded, in local currency and including applicable VAT.

Transaction Services—Preferably Being Existing Services

The existing services comprise preferably a collection of standard services from which the user may select services and comprise preferably a configurable set of additional Services. This collection may typically comprise the following services, whereof some of those may be viewed upon as connection services to external existing system, such as connection services connecting the transaction server to for instance a credit card clearing system:

Calculate Sales TAX or VAT for an Order

Calculate the applicable Duty for an Order

Authorize the total amount on a Credit Card—this service may seen as a connection to external existing systems (a credit card clearing system)

Register the Order for manual credit check and/or Request for Quote

Generate an invoice number, according to merchant and country specific rules

Route the order to the selected warehouse

Refund an amount, either on Credit Card or using other means such as check or bank transfer

Register a shipment event, and trigger billing

Generate messages (send by the Interface Server) triggered by events, such as Order Confirmation and Shipment notification

Order status, to be displayed by the Shop

Order History, to be displayed by the Shop

In the following concretized examples on the business processes listed above are shown.

The examples, preferably define the frame in which the services are to be programmed within.

Calculate Sales TAX or VAT for an Order

In the cases where the VAT is not ‘just’ a part of the price in the catalogue, e.g. for the Sales Tax countries where the Sales Tax must be computed per order, VIDELITY Transaction Services can calculate the applicable Sales Tax and/or VAT, taking into account:

The Merchants business model

The Merchants VAT registration and Permanent Establishment

The Customer information, is he a consumer or business type of customer, is he tax exempt, etc

The specific order and the types of goods/services bought.

The trade scenario for the order, is it a local sale, a cross border sale, a triangular trade sale, are we inside the EU, and so on.

The geographic scope covered is world wide, with capability to compute local vat/tax in initially:

All EU countries

Norway & Switzerland

US and Canada

Australia

New Zealand

Japan

Singapore

Calculate the Aapplicable Duty for an Order

When an order has to be imported in order to reach the customer, VIDELITY Transaction Services can calculate the applicable Duty that either the customer himself pay, or the distributor pays. The result of the Duty calculation is both the Duty amount, and an indication if the customer himself must pay the Duty or the Merchant has an agreement with a company to do it.

Authorize the total Amount on a Credit Card

VIDELITY can integrate to any number of payment service providers, such as WorldPay, Natwest etc. Typically, these companies support the major international cards, plus a number of country specific cards (such as Swift, Discovery). VIDELITY can be configured to access a particular payment service provider, driven by the combination of:

The Merchant

The billing address country

The credit card brand

VIDELITY automatically detects a time-out situation, after a configurable delay such as 30 seconds (most payment service providers have an average processing time of 3-10 seconds). If the connection to the Payment Service Provider is unavailable, or if the Payment Service Provider itself is not available, VIDELITY can be configured per Merchant to simply store the authorization requests, for re-processing when the service is available again.

Register the Order for Manual Credit Check and/or RFQ

In a Business-to-Business type of sale, it is possible for Customer Support to manually perform the line of credit check of the customer, and then release the order for processing. In some situations, the Customer may request a special price, by issuing a “Request for Quote” order. Customer support can see these, contact the customer for negotiation, change the order prices and release the order for processing.

Generate an Invoice Number

Each Merchant may have rules regarding Invoice Numbers, and similarly some countries have rules about the format and range of invoice numbers. These differences include:

The Length of the invoice number

The format of the invoice number, some positions may be restricted to numeric, other to alphabetic, other to alphanumeric.

The Invoice number may depend on the type of invoice, if it is a credit memo or a normal invoice.

* The Invoice number may be assigned a specific range (e.g. starting at 1005001, ending at 1005999, next range 12104001, ending at 12104999, etc)

Route the Order to the Selected Warehouse

The decision which warehouse (or fulfillment center) will be used to process a given order is done by the Shop. VIDELITY is able to format the order into an agreed interface format (such as XML or EDI FACT), and transmit it as FTP files, or via HTTPS.

Refund an Amount

When a customer requests a refund (e.g. because he has returned the goods), Customer Support can create refunds or requests for refund (for release by another person).

There can be one refund for the full amount, or any number refunds of partial amounts (up to the amount charged). The partial refunds can be indicated either as a refunded quantity per line item in the order, or simple as some amount for the order.

Credit Card orders can be refunded to the Credit Card, other orders can result in payment by check or bank transfer.

Register a Shipment Event, and Trigger Billing

When the warehouse has informed VIDELITY that a shipment has occurred (using EDI FACT or XML), VIDELITY will update its order database with the shipment information (such as tracking number) and trigger billing. Credit Card orders will be charged on the Credit Card (via clearing files), other types of orders will result in release of the invoice and booking in accounts receivable of the outstanding amount.

Generate Messages (Using the Interface Server)

When events have taken place, such as an order has been confirmed or a shipment has occurred, VIDELITY can send a message to the customer, either as an e-mail or as an SMS message. The content of the messages is freely configurable by the Merchant, and can have a country specific language.

Order Status

The customer may inquire (through the Shop), what is the status of a particular order. This service will return all available status (such as shipments, refunds) and the Shop will control the presentation to the Customer

Order History

The Customer may inquire (through the Shop), or alternatively the Shop itself may inquire a list of previous completed orders by the Customer. This service will return a full listing of all previous completed orders made by the customer, and the Shop will control how this is displayed to the customer.

VIDELITY allow bundling of Services (such as “Authorize the Credit Card and Route the Order if the authorization succeeded”), and checking of data and sequence. For instance, it can check that the Order number is unique, that mandatory information such as a Ship to Address exists before executing the request.

Adding New Transaction Services

The Merchant or ASP can add any number of additional Transaction Services, such as links to other systems (e.g. access contract and compute an entitled price for a business type customer), new computational or lookup functions—in a very flexible way:

The new service is defined via the Configuration part of the Information and Control Center, including its new data elements and their structure.

Once the new data elements and/or new services are configured, the code generation service will generate a set of program modules, including:

ShopPack module, enabling the Shop to use the new service, using the ShopPack as an API

Data store and retrieval functions, and data definitions for any new tables

A skeleton for the new service, including all necessary support functions. All that remain is that Proactive Software, the VAR or ASP develops the actual logic of the service (for instance retrieval of data, sending a message, doing a computation) in the C language.

The new service is implemented by the Merchant/ASP or a VAR and will be installed into the same infrastructure as the standard VIDELITY Transaction Services.

In this way, all services reside in the Transaction Services engine as services, which can be put in, changed or taken out as needed.

The Databases

The Generic transaction server will store the information it processes:

Maintain a log of all requests, who/what/when

Maintain a log of all input and output for the requests—this database is cleaned up regularly, and its purpose is to assist troubleshooting.

Register all orders, in a format suited for high volume transaction processing.

Feed the Information and Control Center, where it is stored in a relational database and is accessible either via:

The build in processes, screens and reports in the Information and Control center

A Business Intelligence tool

SQL queries

Axapta (ERP)

Axapta is typically a part of VIDELITY full Edition. It will receive information about the completed orders from the ERP pack, and the Merchant can use it for:

Inventory Level Management

Purchasing/Replenishment

Accounts Receivable

Accounts Payable

Accounting

Inventory Level Management

Keep track of inventory levels

Reconcile inventory levels with the warehouse

Generate purchase order requests

Purchasing/replenishment

Generate Purchase Orders based on Purchase Order Requests

Define relationships with suppliers (contracts, negotiated discounts, delivery TAT)

Track Supplier performance

Accounts Receivable

Keep track of outstanding payments, including overdue payments

Maintain line of credit per customer

Generate dunning letters

Book incoming payments

Accounts Payable

Keep track of future payments

Book payments made

Accounting

Define the company account structure (or use the default).

Book all transactions with financial impact, such as:

Goods receive

All sales

All purchases

All accounts receivable and payable

Track cash flow

WebSphere (IBM WEB shop implementation)

IBM WebSphere Commerce Server is part of the VIDELITY full edition. Using the Shop Pack, it utilises the Transaction Services, plus several of the services offered by the Information and Control Center. The standard features include:

Country specific catalogue, with specific national language and prices/currencies, maintained with the Content Management part of the Information and Control Center.

The items are grouped in categories, and can have pictures and multimedia files attached to them.

The customer can see easily if an item is in stock or not, and the shop will decrease inventory levels as orders are generated. The inventory level information is updated frequently, as scheduled batch updates.

Customer registration, with base data such as address, demographics and interest areas for marketing and personalization.

Support of shopper groups with other than list prices. The discount can be implemented either directly on the displayed prices, or as a separate discount amount on the order.

Shopping basket, which will include ALL applicable amounts, such as shipping, vat/tax, duty

Links to documentation repository, plus search facility—maintained by the Information and Control Center

Gift options: special wrapping, shipping to another location or country than billing

Delivery options, typically: Overnight, 2 days, 5 days

Payment by Credit Card, Check, Bank Transfer, GIRO, debit card

Real-time checking of the Credit Card

Frequently Asked Questions—maintained and monitored by the Information and Control Center

Interface Server

The Interface Server comprises a set of standard interface functions, plus any number of configurable interfaces that the ASP or Merchant may need. The interfaces supported can be of these types:

Transaction Services need a real-time interface to some external party or system, e.g. for Credit Card authorization

Transaction Services need a scheduled batch interface to some external party or system, e.g. order files to a warehouse. The batch frequency is freely configurable.

An external party or system need to send batch files, and the interface server can convert these into Transaction services, e.g. the shipment messages from a warehouse gets translated into Shipment events in the Transaction Services.

An external database needs to replicate information into a VIDELITY database, or vice versa

The Interface Server performs the translation from internal VIDELITY format to external format (such as IS08583 for Credit Card transactions), and vice versa. All messages and files are logged in a database, for audit ability.

The standard interfaces include:

Credit Card Authorize, clearing and refund

Orders to Warehouses in EDIFACT format

Shipment notification from Warehouses in EDIFACT format

E-mail or SMS message to the customer (order confirmation or shipment notification)

Technical Comments

The VIDELITY system is preferably to be hosted in a central environment (a data center), but using a distributed hardware-setup instead of a centralized, mainframe system. This enables greater flexibility, scalability and a lower initial investment for ProActive Software to develop as well as for the ASP to deploy.

The lower levels of VIDELITY will preferably run on Linux/Intel platform, which will support up to 10.000 transactions per hour per server. For the high range, the RS/6000 hardware is selected as the common hardware platform. A DB2 database is selected as the central data storage system. A VIDELITY full edition is shown in FIG. 2.

Third-party Customizations

The services in VIDELITY can be changed, taken out, or added.

Any VAR will have the ability to change an existing service or add new services, by accessing a WEB based configurator. Using this configurator, he can define the data and services he needs, and the configurator will automatically generate a set of C or other code modules for his use. The only remaining task is to write the actual business logic (in C or an other programming language), compile and test.

Most Merchants will use a combination of internal VIDELITY services and external services such as legacy systems. To access the external systems, the Interface Server comes with a framework of support functions for interfacing, and the VAR can define any number of real-time or scheduled interfaces to external systems.

Monitoring Facilities

Monitoring facilities is provided through the use of a test canon. This application is a separate box on the net (intranet or internet) and will monitor the VIDELITY configured service from the outside. There will be offered an external testing of the services—based on request. One could then configure it to call an SMS Service component in case of failures—and let operational staff be alerted. Furthermore—it collects the performance measurements and you have the possibility of verifying your availability and overall performance through the reporting facilities.

Additionally, the Information and Control Center has an Operations component, where all alerts are recorded and information is being gathered, e.g. disk space and CPU usage per machine over time, performance statistics etc.

Process Overview

The way a Merchant chooses to setup his store, what and how he sells and fulfills, will of course have an impact to how his business processes will execute.

VIDELITY is able to support any such model, as will be described below.

The primary options are:

The store can sell goods or services

The items sold can be Physical or Electronic

Physical Items can be fulfilled by:

Sold from stock, either at the Merchants existing in-house warehouse or at a 3.rd party fulfillment provider

Manufactured or assembled per order, either by the Merchants In-house process or by a 3.rd party fulfillment provider

Bought from suppliers as orders come in, and delivered directly from the supplier or from a consolidation point. This is called Referral Orders. If the goods are delivered to the warehouse before distribution to the Customer it is called a Drop Shipment, if it is shipped directly from the Supplier to the Customer it is called Direct Delivery.

If there is a high order volume per warehouse, the fulfillment process has to be automated end 2 end, to avoid cost, errors and delays from manual intervention.

If there is a low volume of orders per warehouse, and if system integration is not feasible technically or cost wise, manual ‘rip and read’ order processing should be available

Any mix of the above

Some case stories to illustrate the options, so far only physical goods are covered:

A Web Only Toy Store could choose to sell only stocked items, stored at a 3.rd party warehouse.

A Web only music/video store could choose to sell the ‘hot items’ as stocked items from a 3.rd party warehouse, in combination with other items which are purchased from suppliers if there are orders for them. These purchases are executed as e.g. daily bundles, gathering together all orders per day per supplier. This way the Merchant can have a large number of items in his shop, but avoid a large inventory investment and risk. At the same time, he can ensure that he has stock of ‘hot’ items, thereby being to fulfill quickly to the customer and also avoiding risk of not being able to have a sale if the suppliers run out of stock of the hot items.

1 A Bricks and Mortar Computer Reseller could choose to have a combination of pre-stocked items, assemble per order and purchase from supplier, using his in-house process.

A Web only variant of the above would probably choose to outsource the fulfillment to a 3.rd party

A Web only Outlet Store or Auction site could use 3.rd party fulfillment, the significance is that the supplier initiate the introduction of items into the store.

A Web store that is a front for a number of independent Antiquity dealers could choose manual rip&read fulfillment.

Content Management

The content management process cover:

Introduction of new material

Remove Item from Shop

The models for maintaining content in a set of country specific shops are:

All items are sold in all countries, all prices are in local currency and with local VAT, automatically calculated based on a base price. Local language product titles and descriptions can be supported as a manual step.

All items in a shop for a specific country are in principle independent from those items in the other country shops.

Introduction of new stocked item as shown in FIG. 3

The Sales department identify the new for a new material. They inform Marketing—so that they may consider a campaign. They also make a purchase order request to Purchasing (with requested quantity) using the ERP.

Purchasing identify the supplier (if not given), may change the quantity due to suppliers pricing strategy, availability of items or for contractual purposes, create and send the purchase order using the ERP.

The supplier deliver the items in the ordered quantity to the warehouse, and send an invoice to Accounts receivable.

The Warehouse does Goods Receive, i.e. they check the quantity against the purchase order, and the quality according to QA practices:

A 3.rd Party warehouse uses the Information and Control center to view the purchase order and accept the goods, the Information and Control Center has a link to the ERP who holds the data and process.

An In-house Warehouse typically uses the in-house ERP to control the warehouse, and therefore they would do Goods Receive directly into this

Accounts Payable check the amount on the Invoice, and if the goods have been received OK. If so, they pay the Invoice within the specified time limit using the ERP.

Content Management add the item to the Shop catalogue, putting it in to the appropriate categories, adding any graphics and text, does country pricing based on input from Sales using the Information and Control Center.

A special case exist where the supplier send the goods to the warehouse, triggering goods receive and content management. This is typically where the Merchant has the goods in commission, e.g. for outlets and auctions.

Introduction of a New Non-stocked Item

The process is similar to the above.

For assembled/manufactured items:

Sub parts or raw materials may need to be purchased and stocked

For items that are referred to the Supplier, or are bought as orders arrive:

Skip the purchase order/goods receive/accounts payable steps

Containing Country Specific Content

In a typical scenario, the customer starts his shopping experience by selecting a ‘country’ shop, namely the country where he lives.

Sales Process

This cover:

The Sales Planning, identifying target volumes and items to sell

Process Customer Orders

Process customer orders

Process customer orders are illustrated in FIG. 4.

The Customer creates his order in the Shop

VIDELITY may calculate and add tax and duty if appropriate, and the Customer confirm the order

If the order is of type RFI/RFQ or a configuration support is needed, Sales Support can communicate with the Customer, potentially update the order via the Information and Control Center.

Credit is checked:

VIDELITY will authorize the amount on a Credit Card

For other types of payment, Sales Support can verify the Customer Credit manually, and release the order. Alternatively, VIDELITY can be configured to release automatically.

VIDELITY will route the order to the appropriate party, indicated on the item from the catalogue information:

A Warehouse for stocked items (3.rd Party or in-house)

A plant for assembly or manufacturing

A supplier for referral orders

Fulfillment

Some key aspects of fulfillment:

Money can be taken from a Credit Card, or an Invoice can be send, when the order has shipped.

One order can be shipped in several boxes, each with a tracking number

One order can be fulfilled differently per line item, e.g. some items are stocked and others are assembled

One order can be distributed differently per line item, depending on where it is stocked, its dimensions and weight.

I.e. there can be multiple shipments per order

It is the Merchants choice if there should be one billing per order, or one billing per shipment.

Fulfillment Process Overview

The key differentiating factor is if the Merchant used in-house as shown in FIG. 6 or 3.rd party fulfillment as shown in FIG. 5. The below charts illustrate the high level dataflow involved in Fulfilling the Order, Inventory Management and Payment.

Process flow, 3.rd Party Fulfillment

FIG. 7 shows a process flow for third party fulfillnent.

Inventory Level Management

In all scenarios, the Inventory level Management process take place in the ERP system.

If a 3.rd Party warehouse is used, this will reconcile inventory levels regularly with the ERP system, and do stock counts periodically.

The Shop will receive regularly updates on the inventory levels. It will decrease its view of the inventory levels as orders are created, such that the Customer can see on an item if it is in stock or not.

For items that are not stocked (but instead referred to a supplier or assembled/manufactured per order), the inventory level can be used to manage the capacity of the supplier or the assembly/manufacturing process.

As the Inventory Level Management process is performed in the ERP system, the ERP system needs to know the type of material (pick from stock, refer to supplier or manufacture/assemble)

For stocked items, the Inventory Level Management will define re-order stock level

Customer Payment Process

The following payment scenarios are supported: Credit Card, Debit Card, “Pay before Ship” and Invoice.

The “Pay before Ship” and “Invoice” scenarios typically involve check, giro or bank transfer payments. It is important that these payments are made by the customer with a reference to the order number, such that Accounts Receivable will know which customers has paid for which orders.

One solution for this is to display a text on the Web-shop which the customer is asked to print. The text should be specific to the type of payment:

For check payments he should attach the text to the check.

For Giro payments he should copy the text to the giro form (unless the delivered goods include a pre-printed Giro form, in which case he just has to pay it)

For Bank transfer payments, there are two variants: e-banking and “over-the counter”.

For the last, the text will be an instruction to the customers bank. For e-banking, it will be an explanation how to fill in the form on the web with the key pieces of information:

0. Receiving bank and account number

1. Amount (not all e-banking solutions support other than local currency)

2. Message to receiver (the order number)

Note that in some countries, the bank transfer and giro payments require (or benefit from) using a local bank. The funds thus collected can then be transferred in bulk to the Merchant bank account in his country.

The Credit Card and Debit Card processing is done using a Gateway (payment service provider). The standard product includes build-in support for the WorldPay payment processor, but others can fairly easily be added by the VAR or ASP, or with Proactive Software's support. WorldPay has a substantial multi currency offering, whereby it can authorize in 169 currencies and settle in 22.

Note that it can be beneficial to add local card processing in the major countries, as:

Rates typically will be lower than international processing

This way you can get access to a set of local cards, which may have large market shares in the country

Some banks will add a surcharge to the customer payments for international transactions, will can affect customer satisfaction

A way to Differentiate

The addition of local processing of cards, Giro and bank transfer can thus be a way for an ASP to differentiate themselves from the competition, or can be justified for individual Merchants with large volumes and the need to offer local payment processing to increase their reach to customers in many countries.

Credit Card

The Credit Card is authorized real-time while the customer in finalizing his shopping, and the clearing (request to get the amount authorized) is executed after a shipment of goods or services has been performed.

Debit Card

Some debit cards/gateways support real-time capture of funds from a debit card, others involve a request/response cycle with up to two business days delay (success or failure).

It is possible to have a pending order until the debit card has been successfully processed (which will imply a “pay before ship” scenario), or ship at once and proceed to account receivable processes for the un-successful transactions. Some gateways offer an insurance against failed debit card transactions.

Pay Before Ship

The customer is informed by the shop that he has to pay for the order before it will ship, and the order is pended in the system until payment has been received. The payment can be by check, bank transfer or Giro. Note that a time limit can be set for follow-up with the customers (do they still want the delivery, and why haven't they then paid) or automatically cancellation of the non-paid orders.

In the US, it is required by law that a customer who is unable to obtain a credit card can still buy, which is usually supported with the ‘pay before ship’ scenario, using bank checques. Another typical scenario could be sale of Computers or jewels, which are relatively expensive, and where the risk of fraud is relatively high.

Invoice

The delivery is performed, and an invoice is send to the customer. This is typically used for either low value goods (such as music CD's) or for pre-registered customers with a line of credit. A variant is where the line of credit check is performed manually, i.e. the order is pended until it is released by an operator. The same types of payments are valid as for the ‘pay before ship’ scenario. For Business customers, the format of the Invoice can be either Paper, EDIFACT or XML, depending on the needs and customs of the country in question.

Accounts Receivable

All completed orders are booked in the ERP system, and A/R entries are made. The Accounts Receivables process will monitor the receiving of funds for each payment scenario:

Credit Card

The settlements of funds from the Credit Card companies will be compared to the amounts outstanding, and the A/R records will be closed accordingly. Note that some Credit Card companies will withhold their transaction fees before settlement, whereas others invoice these separately. In both cases, the fees are calculated automatically, and Accounts payable records are booked to account for these fees.

Pay before Ship

The payments are booked, and the orders are released automatically. In the cases where the customers do not pay in due time, the orders are cancelled which leads to a closing of the A/R records.

Invoice

The payments are booked, and action is taken on outstanding payments: Dunning letters, incasso.

Accounts Payable

A/P will record all received invoices, and verify them. In the case of invoices from suppliers of services, they are validated against the contract. In the case of invoices from suppliers of goods, they are validated against the purchase order, and the goods must have been received in agreed quantity and quality before payment can be accepted. The invoices should contain the Merchants Purchase Order number. A/P will normally pay all accepted invoices late, but not later than last day of payment (to avoid penalties). I.e. A/P must continuously keep track of the payments

Business Intelligence

As part of the Information and Control Center, as set of Business Intelligence reports can be executed as shown in FIG. 8.

GENERIC TRANSACTION SERVER AND COMPONENTS

In the following the generic transaction server and in particular preferred embodiments thereof will be addressed.

Transaction Server Components

The Generic Transaction Server provides all synchronous integration facility between the different components—like Services, ERP system, shop, etc. The Transaction Server is the heart of the VIDELITY system.

The Transaction Server consist five elements:

1. Transaction main module

2. Transaction Kernel (Keyword/value pairs—Parsing and insert/fetch functionality)

3. Encryption module

4. Database API

5. Services link to the Transaction Kernel

This is illustrated in FIG. 35.

Mission

The mission of the transaction server is to provide a functionality that can support any transaction based business processes. The server should be optimized for transaction performance and dataflow. From any given configuration in the external Configuration database a specific transaction server kernel is generated. Further it should be possible to change/add services on demand.

This generic flow is described in FIG. 36: It starts out by a business idea or problem.

From this the business requirements can be deducted. Having defined the business requirements it is now possible to configure the actual business model. As the configuration task is ended—the build or generation of a transaction server instance for the actual business requirements is performed. The transaction server and services is therefore built specific to address the actual business idea or problem. Any change in the business requirements will change the configuration and thus a new transaction server instance will be generated.

Transaction Server Model

In order to fulfill the mission goal a transaction model is defined. The model is the framework that the business processes and data must be defined with in.

The model consist mainly of five entities:

Instance (or version)

Service

Keyword

Keyword in Service

Section

The relation between the different entities in the transaction server model is illustrated in FIG. 9 and in FIG. 34. The instance (or version) is the parent entity.

Each entity is clearly defined by a number of attributes. The attributes must be determined in order to enable an automated process for generating a Transaction Server that exactly match the configuration. Attributes for each of the four entities will be specified in the following:

The Service entity is a specific business process required in a given business flow. It could for example be credit card authorization, tax/vat calculation, update of order status, communication to an external business partner, send a WAP message etc. The Service entity is defined by a number of attributes:

| Attribute | Use of attribute in the kernel build |
|---|---|
| Service ID | A unique identifier to the Service |
| Service Route Code | The Code used to Route to The Service |
| Service Description | Description of Service |
| Service Active [Y/N] | Shows if the Service is active |

The Keyword entity holds the information needed for generation the Transaction Kernel and APIs needed by the Service in order to fetch and insert data. The keyword single data entity required by the Service in order to perform the business process. The Service entity is thereby defined by a number of attributes:

| Attribute | Description of the attribute in relation to Kernel build |
|---|---|
| Keyword ID | A unique identifier to for the Keyword |
| Keyword Code | The code used to identify the Keyword |
| Keyword Name | Name of the Keyword |
| Keyword Description | Description of the keyword |
| Keyword Value Type [string, | Type of keyword |
| date, float, integer, etc . . . ] | |
| Keyword Value Type Size | Size of Type (is type requires a size) |
| Keyword Value Default Value | Default value (optional) |
| Keyword link to Section ID | Link to Section (if Keyword appears in a section) |
| Keyword Active Flag [Y/N] | Shows if the Keyword is active |
| Keyword unique Flag [Y/N] | Shows if the Values of the keyword is unique |
| Keyword Index Flag [Y/N] | Shows if the keyword should be marked as an index in |
| | the transaction database |

When using the expression Keyword is it understood that a Keyword always relate to a Value and therefore the term Keyword/Value pair is often used.

The most interesting attribute is the Keyword Code, which for example could be customer name, account number, price etc. In a given Business request for a given Service the Keyword link to the value for example customer name=“John Doe” or account number=“3456045545903489”

A Service normally needs a group of keywords and that lead to the relation entity: Keyword In Service. Some Services will need information (Keyword/value pairs) from an Previously requested Service and therefore a keyword can be marked for an index-keyword optimizing of the search possibility in the Transaction database. In a later section of the documentation a specific example will be illustrated.

The Keyword in Service is the relation between Keyword and Service that also indicates the keywords function in this Service. The keyword has one or more of following three functions: Input, Output and Internal.

The “Keyword in Service” entity also links between different Services (=different business processes) meaning that one Keyword can be Output in Service_{—}1 and Input in Service_{—}2.

The Keyword in Service Link entity is defined by following attributes

| Attribute | Use of attribute in the kernel build |
|---|---|
| Service Code | Link to the Service |
| Keyword Code | Link to the keyword |
| Keyword in use in input flag | Is keyword in use as input in the Service |
| [Y/N] | |
| Keyword in use in internal | Is keyword in use as input in the Service |
| flag [Y/N] | |
| Keyword in use in output flag | Is keyword in use as output in the Service |
| [Y/N] | |
| Service/Keyword Link Active | Is Keyword active in the Service |
| flag [Y/N] | |

Section Entity

Some Keyword can have more than one Value. For example can an order contain one or more order-lines. To represent this in the Transaction model the “Section” entity is introduced. Thereby the one-to-more relation between a Keyword and its Value(s) is defined. But also the possibility that a Section in one Service includes a number of Keyword/Values—and another Services include a fraction of the same Keyword/value pairs in new Section.

The attributes defined for the section entity:

| Attribute | Use of attribute in the kernel build |
|---|---|
| Section Code | A unique identifier to for the Section |
| Section Code | The code used to identify the Section |
| Section Multiflag [M/S] | Is Section of Type Multi or Single |
| Section Begin Keyword | Marks beginning of Section |
| Section End Keyword | Marks end of Section |
| Section Active flag [Y/N] | Is Section active |

Transaction Kernel

The Transaction Kernel is the central part of the Transaction Server. It enables the connections between the Transaction Server Kernel and Services, but also the communication between services. It also performs hashing and indexing on keywords using a generic matrix method which later will be defined. The communication between the Transaction Server and the Clients are carried out using a predefined protocol. This protocol is defined as a string of Keyword/Value Pairs (by a string is understood an array of Characters), including a header that indicates starting position of each Keyword/Value pair. The protocol used for our implementation is defined like this as illustrated in FIG. 10.

The protocol is based on Keyword/Value pairs which means the one business term (or piece of business information) relates to one actual value. For example ORDERNUMBER=12010. Where ORDERNUMBER is the keyword and 12010 is that actual value. It means that ORDERNUMBER will exist in several Transaction Strings (also known as Service Requests) but it will have different values.

The first part of the string (the X1 to X5 values) is the header of the transaction string. X1 gives the actual starting position of the keyword/Value pair “KeywordAA=Value1” (if the first character in KeywordAA is on position 12 in the string then X1=12 and X2 is the Position of the first character for KeywordAB and so on.

As said, the Kernel enables hashing and parsing of the incoming request string (using our predefined protocol) but it also bridges communication between Clients and Services and also Service to Service communication. FIG. 11 illustrates how the Transaction Server is generic when it comes to the number of Services added to the Kernel. But it is also generic in respect to the number of Keyword that can be added to Services.

Also new Services can be plug-in as required—without effecting existing Services. And it can be said that Figure K illustrates the general objective for the Kernel in respect to Services.

All parsing, insert and fetch of transaction data are performed by the Transaction Kernel. The communication to and from the Transaction Server goes through the single Server entry point, and is carried out using a predefined protocol. The data-buffer is parsed into an internal pointer representation, which is optimized for fetch and insert of keyword/value pairs (this method is explained later in the documentation).

The input and output transaction data-buffer is stored in the internal protocol format thereby excluding the need of data normalization between the Transaction Server and the Transaction Server Database. The Transaction database is then replicated into a backend database and normalized into the Business Database. This database is used for reporting, customer support (CRM), BI etc. By mapping every keyword to a normalized data-model it enables the system to generate code for parsing the Transaction data-string (reusing the generated modules from the Transaction Kernel) and also a generation of the physical implementation of the database is provided. And likewise the Transaction Kernel, this functionality enables the possibility of changing/adding Services and Keywords on demand.

Transaction Kernel and Services Building Process

The Kernel Generator performs a number of steps and processes in order to finish the Transaction Server Kernel components. Illustrated by FIG. 12 are the main steps are shown including the configuration of pre-supported Services.

1. Select add, and Configure Services according to the Business Model

2. Store configuration

3. Start Kernel build process

4. Validate Integrity of Configuration data (the result of step 1.)

5. Load and Analyze Service specific configuration data

6. Make a list of Services, Keywords and their relations (link and sections) and use the implementation of the Transaction Model to build (generate code!) a specific instance of the Kernel in respect to the configuration, indexing and parsing.

7. Build pre-configured Service or if new Service is configured then build a code skeleton, compile and assemble code

8. Build Database APIs

9. Repeat if more Services exist

10. Kernel code completed

11. Compile and assemble Kernel code, link Services, support APIs and main module in order to get a complete Transaction Server

12. Generate the business configuration information for the pre-supported Services

Step number 6 is the central part of the Transaction Kernel and Server build and therefore this is treated separately in the next section.

Hashing/Parsing Implementation

In order to comply to the mission that it should be possible to generate the transaction code automatically a general method of indexing and hashing is introduced. The parsing consist of an index hashing based on the first and last character of the Keyword and this results in a matrix structure where the coordinates are represented by [A . . . Z]+[0 . . . 9] (all together 1296 elements).All the elements in the matrix structure holds a pointer to an array of the keyword for each element which complies to the first and last character coordinate. The matrix and the link to the keyword list is illustrated in FIG. 13 (notice that by “KeywordAB” is meant a keyword which first character is “A” and last character is “B”. Using first and last character for indexing gives a reasonable variation of the elements in the matrix with respect to the Keyword list. This method reduces the steps (instruction sets) needed to identify a keyword from any given keyword/value set. If two or more keywords have the same start character and the same end character they are attached to the given array and a simple compare is performed in order to identify the relevant element. The array keeps track of the number of Keywords that complies to this rule. Matrix elements which hase no keyword attached just points to a null-pointer. This is illustrated in FIG. 13.

Further more a data structure (containing all keywords) to hold the Values (from the keyword/Value pairs) in the input string, but also to store output Values from the Services, is generated. This can be done automatically due to the fact the builder knows the attributes and properties for each values in a Keyword/Value pair. Using FIG. 13 as an example and following the steps performed to arrange the Value “Value1” of the keyword “KeywordAB” in the data structure.

The Keyword “KeywordAB” is identified in the data string using the index matrix where the entry on first character is “A” and last character in the keyword is “B”.

This entry points to an array of all keyword that complies to the first-last character rule.

In order to validate that we have a valid Keyword (a not just first-last character match) a compare between the KeywordAB in the data string and keyword in the generated list (link from the matrix) is performed (is more elements exist in the list that comply to the rule, a compare is performed until the Keyword is found). If there is not match the data string is invalid.

Now that the Keyword is fully identified the value is null-terminated (substituting the “:” in the data string with a null-termination) and the pointer from the data structure which represents the keywordAB is set to point on the value, said first character of the value.

Transaction Kernel Build Implementation

This section describes the implementation of the Kernel build process, from business configuration to the ready-to-use Transaction Server. Please note; the following explanation refers to FIG. 12.

The Transaction Server Kernel builder reads the Transaction Model Configuration and using the rules and relations between the entities it generates the Transaction Server code that exact match the business model. Further more a Transaction online tool per service is generated. The Generated code together with the standard Services, encryption and DB API gives a ready-to-compile-and-run Transaction Kernel. Per (new) service a code skeleton is generated and a number of support APIs are included. The business logic/process for each service must at this stage be added.

Note; The Transaction Server is preinstalled with a number of standard business Services like TAX/VAT, Credit card Clearance, ERP interfaces, physical fulfillment. These Services only needs a business configuration according to the Merchants requirements in order to be ready to production. An example of these requirements are information like geographic location of the shop, which countries is to be supported, types of goods/services to be sold in the shop, B2C or/and B2B, etc. . . .

FIG. 14 shows the main-flow of the Transaction Server Kernel generation in respect to the Components developed to this Purpose.

Using the Configuration WUI tool new business services are created. This is executed either by using existing keyword and Sections from the pre-burned Services or by adding new keywords and Sections.

The required configuration is then stored in the Conf. DB. Using the same WUI tool it will be possible to change any attribute on demand.

When the business configuration is completed the Kernel Generator and Test Generator are activated.

The Kernel Generator reads the transaction model configuration and generates first the source module to the Server Keyword Parser module and second a Service code skeleton is generated for each new service. When the business process logic is added to the new Services these are link into the Transaction Kernel together with the encryption (SSL in our case) and DB APIs. And the result is the ready-to-run Transaction Server.

The Keyword Parser Module and encryption APIs are link together with Load test IO Driver modules and provides a specific load test tool.

See also FIG. 35

The Transaction Server is Ready for Clients

The Transaction Server is revoked by a client connecting to the Server and requesting a service. First the decryption of the request data-string is performed thereby also identifying the client for the System. After decryption the server performs a parsing of the data-string and thereby also locates the Service route keyword that identifies the Service requested by the client.

Example of Deployment

This section illustrates how a specific Service is defined and how this is transformed into the Transaction Kernel. The example is a Credit Card Authorization (Where we will call our new Service CCAUTH). This Service could typically be used in a Web shop for handling online payment transaction via Credit Card. In order to simplify the example, only one Service is included in this example—it is normal to have at least 10 Services or more and 200 Keyword/Value pairs or more.

Step 1. Define Service

Define the characteristics of the Service

| | |
|---|---|
| Service ID | 1 |
| Service Route Code | CCAUTH |
| Service Description | Credit Card Authorize request |
| Service Active [Y/N] | Y |

Step 2. Define Keywords

Define the characteristics of each Keyword that you want to include in the Service

| | |
|---|---|
| Keyword ID | 1 |
| Keyword Code | CUSTFIRSTNAME |
| Keyword Name | Customers first name |
| Keyword Description | The Customers first name |
| Keyword Value Type [string, date, float, integer, | STRING |
| etc. .] | |
| Keyword Value Type Size | 30 |
| Keyword Value Default Value | — |
| Keyword Active Flag [Y/N] | Y |
| Keyword unique Flag [Y/N] | N |
| Keyword Index Flag [Y/N] | N |
| Example of Value | “John” |
| Keyword ID | 2 |
| Keyword Code | CUSTLASTNAME |
| Keyword Name | Customer last name |
| Keyword Description | The Customers last name |
| Keyword Value Type [string, date, float, integer, | STRING |
| etc. .] | |
| Keyword Value Type Size | 40 |
| Keyword Value Default Value | — |
| Keyword Active Flag [Y/N ] | Y |
| Keyword unique Flag [Y/N] | N |
| Keyword Index Flag [Y/N] | Y |
| Example of Value | “Doe” |
| Keyword ID | 3 |
| Keyword Code | CCAUTHPAN |
| Keyword Name | Account number |
| Keyword Description | Credit card primary account number |
| Keyword Value Type [string, date, float, integer, | INTEGER |
| etc. .] | |
| Keyword Value Type Size | — |
| Keyword Value Default Value | — |
| Keyword Active Flag [Y/N] | Y |
| Keyword unique Flag [Y/N] | Y |
| Keyword Index Flag [Y/N] | Y |
| Example of Value | 5013501001338949 |
| Keyword ID | 4 |
| Keyword Code | CCAUTHEXP |
| Keyword Name | CC Expiry date |
| Keyword Description | Credit card Expiry date |
| Keyword Value Type [string, date, float, integer, | STRING |
| etc. .] | |
| Keyword Value Type Size | 4 |
| Keyword Value Default Value | — |
| Keyword Active Flag [Y/N] | Y |
| Keyword unique Flag [Y/N] | N |
| Keyword Index Flag [Y/N] | N |
| Example of Value | “0601” |
| Keyword ID | 5 |
| Keyword Code | CCAUTHCUR |
| Keyword Name | Currency |
| Keyword Description | Currency of Authorized Amount in |
| | ISO code |
| Keyword Value Type [string, date, float, integer, | STRING |
| etc.] | |
| Keyword Value Type Size | 3 |
| Keyword Value Default Value | “USD” |
| Keyword Active Flag [Y/N] | Y |
| Keyword unique Flag [Y/N] | N |
| Keyword Index Flag [Y/N] | N |
| Example of Value | “USD” |
| Keyword ID | 6 |
| Keyword Code | CCAUTHAMOUNT |
| Keyword Name | CC Amount |
| Keyword Description | Credit card Authorize Amount |
| Keyword Value Type [string, date, float, integer, | FLOAT |
| etc. .] | |
| Keyword Value Type Size | — |
| Keyword Value Default Value | — |
| Keyword Active Flag [Y/N] | Y |
| Keyword unique Flag [Y/N] | N |
| Keyword Index Flag [Y/N] | N |
| Example of Value | “99.95” |
| Keyword ID | 7 |
| Keyword Code | CCAUTHRC |
| Keyword Name | CC Authorize Return Code |
| Keyword Description | Return Code from Authorize house |
| Keyword Value Type [string, date, float, integer, | INTEGER |
| etc. .] | |
| Keyword Value Type Size | — |
| Keyword Value Default Value | 0 |
| Keyword Active Flag [Y/N] | Y |
| Keyword unique Flag [Y/N] | N |
| Keyword Index Flag [Y/N] | N |
| Example of Value | −10 |
| Keyword ID | 8 |
| Keyword Code | CCAUTHMSG |
| Keyword Name | CC Authorize Return Message |
| Keyword Description | Return Message from Authorize |
| | House |
| Keyword Value Type [string, date, float, integer, | STRING |
| etc. .] | |
| Keyword Value Type Size | 255 |
| Keyword Value Default Value | — |
| Keyword Active Flag [Y/N] | Y |
| Keyword unique Flag [Y/N] | N |
| Keyword Index Flag [Y/N] | N |
| Example of Value | “Modulus check of primary account |
| | number failed” |

Step 3. Link Keywords and Service

After that Service and keywords are defined it is time to link the keywords to the Service.

| | |
|---|---|
| Service Code | CCAUTH |
| Keyword Code | CUSTFIRSTNAME |
| Keyword in use in input flag [Y/N] | Y |
| Keyword in use in internal flag [Y/N] | N |
| Keyword in use in output flag [Y/N] | N |
| Service/ Keyword Link Active flag [Y/N] | Y |
| Service Code | CCAUTH |
| Keyword Code | CUSTLASTNAME |
| Keyword in use in input flag [Y/N] | Y |
| Keyword in use internal flag [Y/N] | N |
| Keyword in use in output flag [Y/N] | N |
| Service/ Keyword Link Active flag [Y/N] | Y |
| Service Code | CCAUTH |
| Keyword Code | CCAUTHPAN |
| Keyword in use in input flag [Y/N] | Y |
| Keyword in use internal flag [Y/N] | N |
| Keyword in use in output flag [Y/N] | N |
| Service/ Keyword Link Active flag [Y/N] | Y |
| Service Code | CCAUTH |
| Keyword Code | CCAUTHEXP |
| Keyword in use in input flag [Y/N] | Y |
| Keyword in use internal flag [Y/N] | N |
| Keyword in use in output flag [Y/N] | N |
| Service/ Keyword Link Active flag [Y/N] | Y |
| Service Code | CCAUTH |
| Keyword Code | CCAUTHCUR |
| Keyword in use in input flag [Y/N] | Y |
| Keyword in use internal flag [Y/N] | N |
| Keyword in use in output flag [Y/N] | N |
| Service/ Keyword Link Active flag [Y/N] | Y |
| Service Code | CCAUTH |
| Keyword Code | CCAUTHAMOUNT |
| Keyword in use in input flag [Y/N] | Y |
| Keyword in use internal flag [Y/N] | N |
| Keyword in use in output flag [Y/N] | N |
| Service/ Keyword Link Active flag [Y/N] | Y |
| Service Code | CCAUTH |
| Keyword Code | CCAUTHRC |
| Keyword in use in input flag [Y/N] | N |
| Keyword in use internal flag [Y/N] | N |
| Keyword in use in output flag [Y/N] | Y |
| Service/ Keyword Link Active flag [Y/N] | Y |
| Service Code | CCAUTH |
| Keyword Code | CCAUTHMSG |
| Keyword in use in input flag [Y/N] | N |
| Keyword in use internal flag [Y/N] | N |
| Keyword in use in output flag [Y/N] | Y |
| Service/ Keyword Link Active flag [Y/N] | Y |

Step 4. If Needed a Keywords to a Section

No Sections are needed for this example—with other words no Keyword/Value pairs appears more than one time and no forced grouping is introduced.

Step 5. Validate data integrity.

The Integrity of the Configuration data is approved.

Step 6. Analyse Service data

Load and analyze Service data. In the example only the CCAUTH Service and the belonging keywords is loaded. First a list of all the keyword is generated and the pointer mapping between the keyword Matrix is performed (see FIG. 15).

After mapping of the Service keywords in the matrix the kernel code reflecting this and the Service code and database APIs are generated. The API's Concerns both fetch and insert of Keywords/Value pairs and their link to Sections.

Step 7. Assembly of the Transaction Server.

The generated code is compiled and the modules are linked together with the main and encryption modules resulting in a ready to run Transaction Server. First, of course business functionality is added to the CCAUTH Service code skeleton.

Step 8. The Transaction Server is up an Running.

The Transaction Server is now ready to receive a request for CCAUTH and parse the incoming string according to the kernel. An example of the hashing and parsing of a transaction string with the example keywords can be seen in FIG. 16 where each keyword/value pair in the incoming string is parsed according to the index matrix.

Step 9. Support from the Kernel to the Service

Using a set of code-generated APIs the Service (in our example CCAUTH) can fetch and insert Keyword/Value pairs on request.

The kernel also generates the response to the client in the predefined protocol format. It could look like FIG. 17.

Use of the Generic Transaction Server

The examples chosen to illustrate the use and implementations of the Generic Transaction Server are mainly focused on area of e-Commerce. But it should be recognized that the Transaction Server in a more general way can serve as an integration component. Said, integration understood as the Transaction Server being the communication carrier between different autonomic or non-autonomic systems where the interface to each system will be implemented as a Service and the Keyword/Value pairs will define the information to be exchanged. One Service could for example understand and handle an XML based data structure while another Service in the Transaction Server could handle some kind of proprietary data protocol and thereby enable integration between so system.

Client Connector

Any processes, system etc. that connects to server (named “client”) in order make use of the services need to conform to the systems business data protocol. Therefore a Client Connecter is generated using the exact same Transaction model and rules as the Transaction Server uses. The Client connector will assist any client in formatting and requesting the Transaction server for a given Service (I our example CCAUTH).

Asynchronous to Synchronous Transaction Handling

In order to support asynchronous to synchronous transaction sequences the interface server is introduced. The Interface Server is described in chapter 6.

Testing of Services

During development and function test of custom services (in case of that extra services are required on top of the preinstalled on VIDELITY) an online web based tool is also generated thereby giving the implementation responsible a very easy to use test-tool. This is a feature that will make sure that a Services is tested correctly but also save resources in spending time on “home grown” test tools.

Interface Server and Components

Mission

On mission of the present invention is to enable asynchronous to syncronous transaction sequences of a computer system comprising a generic transaction server according to the present invention. In accordance therewith, preferred embodiments of the present invention comprises a transaction server and an interface server for supporting such asynchronous to synchronous transactions sequences of the computer system. The interface server preferably comprises a set of interface functions for accessing services being external to the transaction server and one or more connections each connecting a service of the transaction server to the interface server enabling data communication from services of the transaction server and to the interface server, and a connection between one or more of the interface server's interfaces and a Server entry point of the transaction server.

With such a system a service of the transaction server may be able to complete its service without awaiting finalizing of data processing performed by services being external to the transaction server as execution of such data processing is taken care of by the interface server which, when the data processing is finalized, enters the result thereof to the transaction server through the transaction server's entry point.

In the following different components of the interface server will be addressed.

The Scheduler

The scheduler is a central part of the interface server. From the Enterprise Information Portal (a WUI used to control all events related to the system), different interfaces are configured through the web front-end. Part of this configuration is scheduling information for each interface, e.g. any number of Axapta interfaces is going to start at 12.00, every day. This type of information is stored in a configuration database for Enterprise Information Portal (CFG-db). In the Enterprise Information Portals front-end it should be possible to edit scheduling information. When the system operator is finished editing the information it is stored in CFG-db. The Enterprise Information Portal now signals to the monitor that the information can be generated over in the crontab file. Crontab then starts the schedulers at the times specified, in the crontab file, together with all the other scheduled jobs, crontab takes care of.

The scheduler is started with the interface name and the number of interfaces there shall run in parallel, as parameters. This makes it possible for the scheduler to start the needed number of interfaces. Every time an interface is started, it receives the interface name as parameter. The interface uses the name to get interface specific information from the CFG-db and become an interface parent for, e.g. Axapta. To avoid that the interfaces try to access and lock the same information at the same time the scheduler need a sleep function so that the interfaces are started with e.g. 1 sec. delay.

Interface Configuration Change

If changes in the definitions of the interface is made, these changes will be used by the next interfaces of the same type, scheduled, in other words interfaces already running is not affected by the changes, to avoid consistency problems. To avoid that the Enterprise Information Portal update interface specific information in the CFG-db at the same time that an interface is running, there is an “In_Use” field in the CFG-db table, called CFG_In_Use, that is increased with one when an interface is running (decreased before exit). The Enterprise Information Portal is only allowed to change CFG-db information when the “In_Use” is equal to zero.

To give the Enterprise Information Portal a fair chance to perform update in the CFG-db there is a field in CFG_In_Use table where the Enterprise Information Portal can set a flag in the field Start. If this flag is set to NO the scheduler is not allowed to start any interfaces it will therefore send a message to the monitor and then exit.

CFG_In_Use

| Interface | In use | Start |
|---|---|---|
| Axapta | 3 | Yes |

Interface Start and Configuration

The configuration table that is loaded every time a component is started should have five fields: Interface, Stepnr, Path, Parameter, and Maxtime.

The Interface field is a tag identifying the interface, e.g. Axapta. This is the key used to look up information about the interface.

An interface, (can) consists of different steps, components, e.g. a get step to access information, a format step to translate one format to another one and a put step to send the information to whoever wants it. The format component could be step 2 in one interface and step 3 in another, there is therefore need for the Stepnr field to tell the interface parent the right order of the steps in the interface.

The field Path is a full path to a program that can take care of the step and the Parameter field, of course the parameters for the program.

The field Maxtime specifies for how long time a component may run before it exits.

CFG_Data

| Interface | Stepnr | Path | Parameter | Maxtime |
|---|---|---|---|---|
| Axapta | 1 | Get_ftp | | |
| Axapta | 2 | Format_ftp | | |
| Axapta | 3 | Put_ftp | | |

Interface start and configuration is shown FIG. 18

If load of configuration fails, a message will be sent to the monitor, it will be logged and the interface will exit. The message, will be interpreted by the monitor, and a message of some sort will be sent to the system operator, who can take action, and if necessary schedule a new interface. If loading of configuration is successful, the content of what is loaded is logged.

Error reading CFG-data is shown in FIG. 19

Logging

Fail read CFG-data

| | | | |
|---|---|---|---|
| Key | Interface parent name (n) | Message | Time-stamp |

Read CFG-data ok

| | | | | | |
|---|---|---|---|---|---|
| Key | Interface parent name (n) | Stepnr | Path | Parameter | Time- |
| | | | | | stamp |

The next step for the interface parent is to start the different components as independent processes. The interface parent will read in CFG_Data to start the first step with the necessary parameters. The component will run and fetch the next jobs in the queue from the specific interface, work, and will then exit, with a return code. The interface parent will then start the next step in the component chain. When all the steps in the component chain have returned with no error and maxtime is not overdue, the interface parent starts a new component chain.

This circle will continue until all the steps in a component chain return a massage telling the scheduler that there is nothing more to do. The interface parent then exits.

If any of the components fails, a message will be sent via the interface parent to the monitor and it will be logged. The interface parent then starts the next step in the component chain.

If a component is running for longer than the maxtime specified in the configuration, a message is sent to the monitor and it will be logged. It is then up to system operator to take action.

Logging

Component start

| | | | | | |
|---|---|---|---|---|---|
| Key | Interface | Component | Step | Parameter | Time-stamp |
| | parent name (n) | name | | | |

Component return

| | | | | | |
|---|---|---|---|---|---|
| Key | Interface | Component | Step | Return code | Time-stamp |
| | parent name (n) | name | | | |

Interface parent finish with success

| | | |
|---|---|---|
| Key | Interface parent name (n) | Time-stamp |

Maxtime overdue component still running

| | | | | |
|---|---|---|---|---|
| Key | Interface parent name (n) | Component name | Step | Time-stamp |

Interface Resource Control

If a number of interface parents are running, uses the same resource, lets say net resources, a bottleneck could occur or worse the whole system could crash. This gives rise to a way of controlling the number of processes using a specific resource. On the other hand it is also important to utilize the resources available. We will describe one method that does both (almost, it's controlled by humans).

Before a component is started, the interface parent performs a resource check. The interface parent reads in the Component_Resource_Table what kind and quantity of resources the component needs.

The component_Resource_Table is configured from Enterprise Information Portal during interface set-up. It contains a list of all the resources a component needs.

Component_Resource_Table

| Component | Resources | Quantity |
|---|---|---|
| Get_ftp - | Resource- | 1 |
| Axapta | 1 | |
| Get_ftp - | Resource- | 1 |
| Axapta | 2 | |
| Get_ftp - | Resource- | 2 |
| Axapta | 3 | |
| Put_ftp - | Resource- | 1 |
| Axapta | 2 | |
| Put_ftp - | Resource- | 4 |
| Axapta | 3 | |

Now the interface parent checks in the Resource_Table to find out if the necessary resources are vacant in the requested amount. If this is the case the interface parent add quantity to the Current field and starts the component.

Resource_Table

| Resources | Max | Current |
|---|---|---|
| Resource- | 500 | 500 |
| 1 | | |
| Resource- | 700 | 200 |
| 2 | | |
| Resource- | 40 | 4 |
| 3 | | |

The illustration in FIG. 20 shows that only component put_ftp Axapta will start, because component get_ftp Axapta need a non-vacant resource (R-1). Resource allocation of a specific component is also shown in FIG. 20.

The interface parent for the component get_ftp Axapta will now send a message to the monitor indicating that there were no vacant resources for get_ftp Axapta and then exit.

Logging

No resources maxtime not overdue

| | | | | | | | |
|---|---|---|---|---|---|---|---|
| Key | Interface parent | Component | Step | Resource | Quantity | Quantity | Time- |
| | name (n) | name | nr. | missing | required | vacant | stamp |

The Queue

The transaction services, Tx, puts request into the Transaction queue. This communication is not via a process in the interfaceserver, but Tx writes directly into the interface servers database, in other words there is no queue manager.

The queue consists of three tables, one holding primarily status information and the two other ones holding data. The first table, Queue Status, consists of the following fields Queueid, Interface, Completed, Status, Timestamp, Priority, Alt_Interface and Lock. The second table, Queue_Data, consists of the fields Queueid, Stepnr, Resends, Userinfo, Control, Data and Ext. The third table, Queue_Data_Ext consists of the fields; Queueid, Stepnr, Rownr and Data. Queueid is a unique number identifying the request. Then there is a field identifying the interface. This is very important, because the component fetching request from the queue, have to fetch the requests for the specific interface they are initialized to. For example, the interface Axapta, uses a general put_com component, but is has to know that it is working for the Axa pta interface in order to be able to fetch Axapta requests from the queue.

Then there is a Priority field, reasonable enough, some requests should be processed before others and it should be possible to send some request fast through the interface server. Every time a row in the Queue_Status is changed a new timestamp is inserted into the field Timestamp. The reason for this is that the components selects requests from the queue ordered by priority and timestamp. By doing this a request that cannot be processed of some reason, will be put back into the queue with a new timestamp and fetched again some times later. If there is no time stamping, the request will be fetched immediately again if it has a high priority, not put in the end of the queue for that priority, like it should.

The three other fields, except for the field Lock, contains different type of status information, we will come back to them later in this document. The field Lock is used to indicate that a row is being processed by a component. Queue_Data contains the output from the different steps, including the data written by Tx. The field control contains information used by the individual component. A component can in addition to storing output data, need to put control information somewhere, e.g. a format component wants to store how much has been formatted, so that if it fails, the format step does not have to be started all over again.

It also includes a field Userinfo, containing information that the component needs to know about the specific request, e.g. a put ftp component needs to know to which server to connect to and with what username and password. Queue_Data also includes a status field Resend and a field Ext, indicating if the data cannot fit the data field. If that is the case the third table queue data_ext will be useful. In this table the extra data will be stored for a defined queueid, stepnr using rownr to number the different rows of data.

Queue_Status

Queue_Status

| Queueid | Interface | Completed | Status | Timestamp | Priority | Alt_interface | Lock |
|---|---|---|---|---|---|---|---|
| 111 | Axapta | 1 | No | 11-10-2000.17.12.30.000000 | 1 | Primary | 997 |
| | | | error | | | | 6 |
| 112 | Axapta | 0 | No | 11-10-2000.17.12.31.000000 | 1 | Secondary | 0 |
| | | | error | | | | |

Queue_Data

| Queueid | Stepnr | Resend | Userinfo | Control | Data | ext |
|---|---|---|---|---|---|---|
| 111 | 1 | 0 | | | | 1 |
| 111 | 2 | 0 | | | | 0 |
| 111 | 3 | 1 | Server=web-log | | | 0 |
| | | | user=mkn . . . | | | |

Queue_Data_Ext

| Queueid | Stepnr | Rownr | Data |
|---|---|---|---|
| 111 | 1 | 1 | |
| 111 | 1 | 2 | |

When Tx wants to use the interface server, it queues the request, by generating a new queueid, and inserting a row in Queue_Status with the right interface and priority. The field Completed is set to 0, no steps have been completed yet. Status is set to no error.

The actual data being sent is inserted into Queue_Data, using the generated Queueid, and setting Stepnr to 0. Userspecific information for each step is added to the Userinfo field, for each step that has any use for that type of information. If the data can not fit the field Data in the table Queue_Data, the Ext. field will be set to 1, else it will be set to 0, and the data will be inserted in the number of rows that are needed. All access to the queue is through an API.

Components

The interface parent starts the different components that are going to fetch requests from the queue with the interface as parameter. This way the component knows what type of requests to fetch from the queue. For example the component get_ftp, could be used by a number of interfaces, and has to know which interface it is working for. The interface has been configured with a number of components doing the different steps.

The interface parent for a specific interface forks first a childprocess for step 1. When step one is finished it forks a childprocess for step 2 and so on until the whole process is finished. To get speed and maximize the use of the resources a number of interfaces of the same type can be running at the same time.

Another parameter the component receives is Stepnr. Again the reason is of course that the component could be doing any step. It has to know which step it is working at, to update status information correctly and direct output of data to the right place. If the load operation fails, the field Status in the table Queue_Status is set to error. A message is sent to the operator and it is logged and it is up to the operator to change the status back to no error and set the right priority, to get the request processed once more.

When the component fetches requests from the queue it selects Queue_id's with the interface it received as parameter, and Status equal to no error, in other words the requests with status equal to error will never be processed. The component also only fetches requests that are not being processed by another component, in other words requests with lock equal to zero. The field Completed contains information about the last completed step. The component fetches requests with the field Completed equal to it's Stepnr minus one, e.g. a component taking care of Stepnr 2, fetches request with the Completed field set to 1. These elements are sorted by priority and timestamp, and the first one is fetched. Before starting the processing, the component sets the field Lock to it's processid, for the row in question. After successfully finishing, the component ads one to the Completed field, and sets the Lock field to zero, and the successful completion is logged. It is important to Lock the row that is being processed by a component. If this is not done, several components could end up fetching and processing the same request. For example, there could be several Axapta interfaces scheduled to start at different times, which will run at some specific time. Then we have a situation were several identical component are processing the same requests. By having a process pr step and locking each request with a processid, it is possible to see at any time which process that is doing the different steps for the different requests. It should then be possible in the Enterprise Information Portal to create a web front-end that could display the different requests and steps being processed, with different types of resources being used. If there are no more requests to process, the component returns a value signaling this to the interface parent.

Resend

If the component, fails for some reason, a message is sent, it is logged and one is added to the field Resend. Technical speaking a message is inserted into the message queue and it is up to the monitor to process it. One example could be a put_ftp component that could not send the data. The field Resend describes the number of times the request has tried being processed by a component. If the field Resend becomes equal to a maximum number of resends allowed, the field status is changed to error. The maximum number of resends, comes from the user information to the individual component, and depends not only of the component, but also of the individual connection to the server. When the status is error for a request in the Queue_Status table, none of the components will fetch the queue element and start processing it. It is up to operator to change the status back to no error. On the other hand a message is sent to the operator, and there will be a web-front end to the Transaction-queue, were it is possible to change status and priority. The operator can then change status, and set a high priority on the Queue_Status table if he wants it to be processed fast. This way, when a problem occurs, and a component fails to process a request, it will until a maximum number of resends, be put back into the queue and start all over again with the step that failed, but on the other hand if something very serious is wrong, the only way to get it processed is by manual intervention.

Alternative Interfaces

To make communication more stabile, it is possible to define a secondary interface. This means that if it is not possible to send information via the primary interface an alternative interface will be used, e.g. an interface using put ftp fails, even after resending several times and an interface using put_fax is used instead. The component receives the name of the secondary interface as a parameter, if there is such a thing defined. Not all interfaces will have a secondary interface. When the component fetches a request from the queue and the resend field is the maximum allowed, instead of changing the status to error, the component changes the field Interface in the queue, sets the fields Resend and Completed to zero. This means that a new interface is going to be used to process the request. The component will go on fetching new queue elements. If the secondary interface is running there will be a component that at some time will fetch the queue element and it will be processed by a secondary interface. The same Queueid is used when processing the request with the secondary interface and the field Completed is reset. This means that the process starts all over again for the new interface and the data in the table Queue_Data is overwritten. If a component in that secondary interface fails, the status field will in the end be set to error, and a message is sent and manual support has to intervene. The reason for resetting the field Completed is that the processing of the secondary interface has to start from the beginning, e.g. the alternative interface may use other steps in processing a request.

User Specific Information for Components

Every time a component fetches a new request in the Queue_Status, it has to get user specific information, e.g. a put_ftp has to get information about the server it is going to communicate with, the username and password. This type of information depends on the request that has to be processed, and can change from request to request. The field Userinfo in the table Queue_Data contains this information. The field is a text field with user specific information in a keyword-value format that is easy to parse by the component. Each specific component knows what type of information to expect, if it does not get the necessary information, the status for the request is set to error and a message is sent, it is logged and it is up to the operator to change the status back to no error for further processing.

Resource Control for Components

In the interface parent there is resource control. Before starting the different components, a check is made in the Resource_Table to see if the interface parent is allowed to start the component. This is very general in the way that there is no resource control on the communication with the different servers or customers. However, the problem can arise, that there should be some limitations on the number of connections to different servers, e.g. only one component at a time is allowed to communicate with web-logistics. To solve this problem, a check is made in the Resource_Table, to see if it is possible to communicate with the server. The Resource Table, used by the interface parent, can also be used for this purpose. In all cases involving communication with a server, the user information parsed by the component includes information about the server. This can be used to look up resource information in the Resource_Table. That way it is possible to check if it is possible to communicate with the specific server in question. If it is, the field Current in the Resource_Table is updated and communication is started. If it is not possible, the request is put back in the queue, and a message is send and it is logged. The request is put back into the queue with the Resend field in the table queue_status updated with one. If the Resend field is equal to or greater than the maximum resends allowed, the request is put back into the queue with a different interface, in the same way that will happen to a request if something else has failed a number of times.

FIG. 4.

| Resgroup | Max | Current |
|---|---|---|
| Web-log | 1 | 0 |

In FIG. 21 is illustrated the outgoing part of the interface server. The ingoing part will be described in a later document. Please remember that the output, e.g. a file, could be directed to Tx. This file would have to pass a queue and a dripfeeder and has not been designed in detail yet.

Scheduler Start options

Status information about running interface server processes are stored in different ways. In the table queue_status, there is a field lock. This field contains the PID's of the steps running. For the requests that are not being processed, the field contains a zero. In the table cfg_in_use, there is a field in-use. This contains the number of interface parents of a specific type that are running. Then there is resource control, with the fields current in two tables. These fields contain the number of resources used at the time by different processes. All of this is status information about the different interface server processes running. If somebody kills a process or turns off the interface server or a process abort suddenly these types of information will not be updated. The result could be that steps cannot be processed, because of resource control blocking the start of the steps. Another problem could be that the field lock is set to a nonzero result for the request. This signals that the request is being processes, so that other interface parents will not start processing the same request. However, if the process has been killed for some reason, the request will never be processed. A third problem is if the field in use is nonzero for an interface and the interface is not running, because the scheduler was killed. Then it will not be possible to change the configuration of the interface, it will be locked.

The problems above all occur because status information about the different processes running are incorrect and have to be updated. We suggest a check option for the scheduler. This means that it should be possible to start the scheduler with this option and the scheduler will check if the information about the different processes are correct. If it is not, the differences will be logged and sent as messages, so that the operator will be alerted. One way of trying to find out about these type of problems, is by adding scheduler calls with the check option in the crontab file, so that checks will be done regularly. This check should be done for all interfaces, no interface argument should be used.

We also suggest a sync option. If the operator finds out that there are some differences, after investigating the problem, he can start the scheduler with the sync option. This will force an update of the information about the processes running.

This should also be done for all interfaces and no interface argument should be used.

Another suggestion is a restart option. Many problems could be solved by killing the processes and starting everything up again. This means that the scheduler started with the restart option should kill the different processes, start the scheduler again and update the information about the different processes running. This should be done for each interface.

We suggests storing the information about the different interface server processes in a table, see Table PID. We have two reasons for it. The first one is that it could be an advantage for the operator to get an overview of the different interface server processes running, what they are doing and when they are started. The other reason is that that if this table is updated, it is easier to update the process information in the other tables. The table name is PID and consists of the fields Pid, type, name, parent, server and timestamp. Each processid is inserted in the pid field with its type. The types can be scheduler, interface parent and step. The parent field contains the parent process name for components(steps). If not it is empty. The server field contains a server name for certain components, e.g. a put_ftp. If not it is empty. The table is updated every time an interface server process is started or exits. The schedulers and interface parent processes updates the table themselves, while the PID information for the different steps is updated by the interface parent.

We will in the following describe in detail the way, the process information in the database is updated. That means a description of how the sync option should work. The check option works similar except that there is no updating. First of all the PID table is updated. This is done by searching through the PID table and checking if the pid entries are really running processes. If the interface server runs on several nodes, this has to be done at all of them. If not the entries from the table are deleted. This means that any process that was killed, aborted, or stopped in any way without updating the status in the pid table, will get it's pid information removed from the table. With this table updated it is possible to update the other tables. The field in use in the table cfg_inuse contains the number of interface parents of a specific type running. This can be updated by searching through the pid table and counting the number of interface parents running for each of the interfaces, and updating the different inuse fields. The field lock in the table queue_status, is set to the PID of the different steps processing the requests. By searching through all the locks set to a nonzero value, and checking if they are running, through the PID table, the lock field will be updated correctly. The resource check at the interface parent level, checks if there are resources to start the different components necessary. This is done by searching through the resources with resources reserved(current nonzero) in the resource_table, looking up the components in the component_resource_table. By searching through the PID table, it is possible to find out how many of each component that is running and thereby update the current field in the resource_table. Resource check at component level, consists of checking if there are limitations on communicating with a specific server, e.g. only one component at a time can communicate with web-log. This is done by searching through the resource_comp table, the rows containing a nonzero current field and checking if any are running through in the PID table and updating the current field.

TABLE PID

| PID | Type | Name | Parent | Server | Timestamp |
|---|---|---|---|---|---|
| 1234 | Scheduler | Axapta | | | 11-10- |
| | | | | | 2000.17.12.30.000000 |
| 2000 | Interface | Axapta(1) | | | 11-10- |
| | parent | | | | 2000.17.12.31000000 |
| 3001 | Step | Put_ftp | Axapta(1) | Web- | 11-10- |
| | | | | log | 2000.17.12.32000000 |

Logging

To be able to trace what the system has been doing it is necessary to log what is done.

There is need for 3 standard fields in all logs;

A key there tells what the log is describing

Time stamp

A field telling if the log line may be deleted.

The key field describes what information there is in the log line, e.g. key=10 tells that the line is log for the start of an interface parent.

The time stamp is used for describing when the log line was written and for housekeeping (delete all lines older than . . . ).

The delete log field can be set to 1 or 0. If it is set to 1 the log line may not be deleted during house keeping. There may be log lines there will shall be used for later documentation and therefore must be copied into at historic-database.

There could be one log for all parts of the system consisting of 4 fields, where the fourth field is a data field in in-house format there contains the following information.

| | | Delete | |
|---|---|---|---|
| Key | Time stamp | lock | Txt in-format |
| 10 | 11-10- | 0 | Interface = Axapta; |
| | 2000.17.12.30.000000 | | In_Use = 5; Start = Yes |

The following describes what the different parts if the interface servers do in detail.

Scheduler Steps

1. Read content of In_Use_Table

2. Evaluate content of In-Use table

3. Exit if Start field=No

4. Update In_use_table In_Use=In_Use+n

5. Evaluate return code from db

6. If return code=error start at 4.

7. Else start n interface parent

Logging of Scheduler Steps

1) What is read from In_Use_Table

Interface name, Values

3) If start=No

Scheduler name, Interface name

7) Start n interface parent

Scheduler, interface parent name, P-id (one line pr. interface parent.)

Interface Parent Steps

1. Read CFG_Data

2. Evaluate CFG_Data

3. If CFG_Data not ok then exit

4. Read Component_Ressource_Table

5. Read Resource_Table

6. Evaluate on all resources

7. Exit if missing resources

8. Update Resource_Table

9. Evaluate return code from db

10. If return code=error then start at 5.

11. Else start component

12. Evaluate return code form component

13. If error code=error then

14. Update Resource_Table

15. Evaluate return code from db

16. If returncode=error then start at 14.

17. If maxtime overdue start step 19

18. If all return codes ok start step 19. else start 1.

19. Update In_Use table

20. Evaluate returncode form db

21. If return code=error then start at 19

22. Exit

Logging of Interface Parent Steps

1) Evaluate CFG_Data not ok

Interface parent, data read

2) Evaluate CFG_Data ok

Interface parent name, Step, Path, Parameter, Maxtime

7) Exit if missing resources

Interface parent name, component name, missing recourses name, quantity, available

11) Start component

Interface parent name, component, P-id

13) Evaluate returncode from component

Interface parent name, component, return code, P-id

22) Exit with success

Interface parent name

22) Exit maxtime overdue

Interface parent name

Component Steps

1. Read Queue_Status for next job

2. If no job then exit with return code

3. Lock job

4. Evaluate job lock

5. If job lock not ok then start at 1.

6. Read Queue_Data

7. Evaluate Ext

8. If Ext=1 then Read Queue_Data_Ext

9. Evaluate data ext

10. If data ext not ok then exit

11. Work (this is unique from component to component)

12. Update in Queue_Data (Queue_Data_ext); Data (output)

13. Update in Queue_Status; Completed, Status, Timestamp, Lock

14. Return code to interface parent

Logging of Component Steps

2) If no job then exit with return code

Component name

10) If data ext not ok

Interface name, component name, step, Queue id

14) Return code to interface parent

Interface, component name, step

Process for the Outgoing Part of the Interface Server

An interface is defined as a number of steps/components that has to be executed in sequence. For example a get_ftp step that gets a file from ftp and format step that formats the data to some other format and put ftp step that sends the data.

The configuration of the interface is done in the Enterprise Information Portal and stored in a database. Scheduling of the different interfaces is also configured in the Enterprise Information Portal, e.g. an Axapta interface is scheduled to start at 12.00. After the scheduling information is stored in the database, a signal is sent to the systems monitor. The systems monitor then generates the scheduling information into the crontab file. The crontab process, a simple Unix scheduler, looks in the crontab file for jobs to start and starts them at the specified time. Crontab then starts the interface servers scheduler process, specifying the interface name and the number of interfaces that should run in parallel, e.g. 10 Axapta interfaces should be started. The interface servers scheduler then starts a number of interface parents, e.g. 10 Axapta interface parents. Each of the interface parents started then takes care of executing the different components/steps in a sequence. First the first step is started and when that is finished, another step is started and so on until the whole sequence has been executed. When that is the case, a new sequence of steps is started and executed.

The different steps/components starts by looking in the queue and fetching a request. This is the place were all the requests/jobs are put, e.g. Transaction Server instance puts requests/jobs that has to be executed. The next component started then fetches the data processed from the last component and starts processing that data and writes it to the database, until the whole sequence of steps have been executed. The information fetched includes data and parameters for the component. The parameter data for the component is for example server name, username and password for a get_ftp component. With Data means the data that has to be processed, e.g. data fetched by get_ftp, that has to be processed by a format component.

The following describes the processes of the outgoing part of the interface server when no error occurs.

1) New Configuration Data

New configuration information for the crontab file is added in the CFG-db. Enterprise Information Portal sends a signal to the monitor that there is new information. The systems monitor needs to know when scheduling information has changed or been added. The reason is that it is the systems monitor that has to generate then scheduling information into the crontab file. The way the systems monitor is going to be signaled has not been decided yet (see FIG. 22).

2) Update the Crontab File

The monitor generates the information into the crontab file (see FIG. 23)

3) Scheduler/Interface Parent Start

Crontab starts interface server schedulers as specified in the crontab file. Every scheduler is started with an interface name and how many interfaces there shall run in parallel as parameter. The scheduler starts the specified number of interface parents (see FIG. 24).

4) Component Start

The interface parent first reads the CFG db using the interfacename as parameter to get the numbers of steps in the component chain. Then it reads the CFG db to get Path, parameter (if any) and maxtime for the first component in the component chain. The first component in the component chain is started with the interface name, step and (if any) parameters (see FIG. 25)

5) Component Work

The component uses the interface name and previous step as key to find the next job, and thereby queue id, in the interface server queue. If there is an entry in the queue the component locks the row using its process id as lock to avoid that other components process the same request.

In the interface server queue for component the component uses the queue id as key to get user specific information and the number of how many times the request have been processed.

The next step for the component is to get input data. In this example the component get it's information from the interface server queue data table. The data could have been e.g.

file fetch by ftp. The component uses the queue id and step to get its data.

The component now processes the data as illustrated in FIG. 26.

6) Write Data and Exit

When the component has completed its work with no errors it writes, in this example, its output data to the queue data table using the queue id and the next step as key.

The component now releases the lock on the request by setting the field lock to zero and set the field completed to its own step.

The component now exit with a return code to the interface parent see FIG. 27.

The interface parent now starts the next step in the component chain, if any, else it start the first step in the component chain. This will continue until all components in a component chain have returned a code indicating that there is nothing more to do. The interface parent will then exit.

Interface Server DB API

The interface parent loads the definition of the interface one step at a time. Two functions in the db API is used for this. The first function, numberofsteps, returns as the name implies the number of steps that an interface consists of. This means a function signature numberofsteps(interface, nosteps). The function returns 0, if no error occurs and nonzero integer indicating an error. The second function interfacestep returns the components path, parameters and maxtime, when the interface and stepnr is specified. This means that it is up to the interface parent to iterate through the number of steps and call interfacestep to get the definition of each component. The function signature is therefore interfacestep(interface, stepnr, path, parameter, maxtime). The function returns zero if no error is detected and a nonzero result if an error is detected.

Logging in the interface server is done through the log function call. This function takes as arguments a key, indicating what is logged. An optional delete flag indicating whether the row logged should be deleted by housekeeping routines or not, and a log txt in keyword value format. This means that the function signature is log(key, deleteflag, logtxt). A timestamp is automatically inserted for each row of the log and a rowid is automatically generated, adding on to the largest one. The return value is zero if no error was detected and nonzero if an error occurred.

The different components need two function calls. One for getting information, before starting processing and one for putting information to the database. The first one getnextreq, as the name implies, gets the next request in the queue. The function gets the next request for a specific interface and stepnr. It returns data from the last step, control information, userinformation and queueid. Queueid, gives a reference to the request. If data is stored in several rows, the rows are concatenated and returned as one string. The lock flag is also set, indicating that the request is now being processed, so that other interfaces will not start processing it. The function selects the requests for the specific interface and stepnr with status equal to no error and the lock flag set to 0. This way, only requests with no error that are not being processed are fetched. The fetched rows are ordered by priority and timestamp. This means that the function signature is getnextreq(interface, stepnr, data, control, userinfo, queueid) and returns zero if no errors are detected and nonzero if errors are detected.

The function putinfo, writes data to the database. With data means both data and control data. This is done for a specific queueid and stepnr. This means that components using the function, first gets the next request and receives a queueid and uses this queueid later, when the processed data is written to the database. If data is longer than 2000 characters, the data is split up into n parts, all smaller or equal to 2000 characters. These parts are inserted into separate rows. If this is successful, the completed field is updated by one and the lock field is set to zero. The timestamp is also changed. This means that the function signature is putinfo(queueid, stepnr, data, control). The function returns zero if successful and nonzero if an error occurs.

Data Flow and Database Design

This Section is the first version of the data model for the Interface Server Application.

The data model is divided into three logical areas

The Application/Interface schedule and configuration

The Interface request

The Processing data

The Application/Interface Schedule and Configuration

The configuration of interfaces involves setting up the schedule for the application, which components is in the interface/application. For each component the status codes, the needed parameters and restart parameters are configured. When a component is added to an interface/application the sequence of components is entered and the actual parameters and restart parameters in keyword/value is given. Please refer to FIG. 28 for a graphical illustration.

The Interface Request

The requests are put in queues. There will be a queue for request from the transaction server, one from external system, normally a HTTP request. For interfaces putting requests back to the transaction server an interface request will be put into that queue. For each request there will be an input data table with data in keyword/value format.

Please refer to FIG. 29 for a graphical illustration.

The Processing Data

When an interface/application with a schedule is started/ended this is logged. Each processing component for the started application and the request for the application is updated with a status code for the how the processing went. The components control data and output data is put into tables and possible a dripfeed request is put into the queue for the transaction server. Depending of the component the important progress is logged.

Please refer to FIG. 30 for a graphical illustration.

TABLE design

| | | | | Column is |
|---|---|---|---|---|
| | | | Column Null | Primary |
| Table Name | Column Name | Column Datatype | Option | Key |
| Application_Component_{—} | Application_ID | CHAR(12) | NOT NULL | Yes |
| has_Parameter | Component_ID | CHAR(12) | NOT NULL | Yes |
| | Values_for_Parameters | VARCHAR(2000) | NULL | No |
| Application_Component_{—} | Application_ID | CHAR(12) | NOT NULL | Yes |
| has_restart_Parameters | Component_ID | CHAR(12) | NOT NULL | Yes |
| | Values_for_Restart_Para | VARCHAR(2000) | NULL | No |
| | meters | | | |
| Application_has_Components | Application_ID | CHAR(12) | NOT NULL | Yes |
| | Component_ID | CHAR(12) | NOT NULL | Yes |
| Application_has_Schedule | Application_ID | CHAR(12) | NOT NULL | Yes |
| | Schedule_ID | CHAR(12) | NOT NULL | Yes |
| | End of_Practise_Date | DATE | NULL | No |
| | Start_of_Practise_Date | DATE | NULL | No |
| Application_Interface | Application_ID | CHAR(12) | NOT NULL | Yes |
| | Application_Description | CHAR(60) | NULL | No |
| Component_need_Parameters | Component_ID | CHAR(12) | NOT NULL | Yes |
| | Parameter_ID | CHAR(12) | NOT NULL | Yes |
| | Format_of_Parameter | CHAR(60) | NULL | No |
| Component_need_Restart_{—} | Component_ID | CHAR(12) | NOT NULL | Yes |
| Parameters | Restart_Parameter_ID | CHAR(12) | NOT NULL | Yes |
| | Format_of_Restart_Parameter | CHAR(60) | NULL | No |
| Component_Output_Data | Application_ID | CHAR(12) | NOT NULL | Yes |
| | Component_ID | CHAR(12) | NOT NULL | Yes |
| | Request_ID | CHAR(12) | NOT NULL | Yes |
| | Schedule_ID | CHAR(12) | NOT NULL | Yes |
| | Component_Output_Data | VARCHAR(2000) | NULL | No |
| Component_Step | Component_ID | CHAR(12) | NOT NULL | Yes |
| | Component_Description | CHAR(60) | NULL | No |
| | Maximum_Number_of_{—} | INTEGER | NULL | No |
| | Attempt | | | |
| | Maximum_Process_Time | DATETIME | NULL | No |
| | Path_to_Component | VARCHAR(255) | NULL | No |
| Dripfeed_Request | Application_ID | CHAR(12) | NOT NULL | Yes |
| | Request_ID | CHAR(12) | NOT NULL | Yes |
| Dripfeed_Request_Input_{—} | Application_ID | CHAR(12) | NOT NULL | Yes |
| Data | Dripfeed_Request_ID | CHAR(12) | NOT NULL | Yes |
| | Sequence_Number | INTEGER | NOT NULL | Yes |
| | Input_Text | VARCHAR(2000) | NULL | No |
| HTTP_Input_Data | Application_ID | CHAR(12) | NOT NULL | Yes |
| | Request_ID | CHAR(12) | NOT NULL | Yes |
| | Sequence | INTEGER | NOT NULL | Yes |
| | Input_Data | VARCHAR(2000) | NULL | No |
| HTTP_Request | Application_ID | CHAR(12) | NOT NULL | Yes |
| | Request_ID | CHAR(12) | NOT NULL | Yes |
| Log_for_Application_{—} | Application_ID | CHAR(12) | NOT NULL | Yes |
| Schedule | Log_System_Key | INTEGER | NOT NULL | Yes |
| | Schedule_ID | CHAR(12) | NOT NULL | Yes |
| | Ended | DATETIME | NULL | No |
| | In_error | DATETIME | NULL | No |
| | Started | DATETIME | NULL | No |
| Log_for_Component | Application_ID | CHAR(12) | NOT NULL | Yes |
| | Component_ID | CHAR(12) | NOT NULL | Yes |
| | Log_System_key | INTEGER | NOT NULL | Yes |
| | Request_ID | CHAR(12) | NOT NULL | Yes |
| | Schedule_ID | CHAR(12) | NOT NULL | Yes |
| | Audit_Timestamp | DATETIME | NULL | No |
| | Delete_Allowed | CHAR(1) | NULL | No |
| | Log_Description | VARCHAR(255) | NULL | No |
| | Log_Header | CHAR(12) | NULL | No |
| | Log_Text | VARCHAR(2000) | NULL | No |
| Parameters | Parameter_ID | CHAR(12) | NOT NULL | Yes |
| | Parameter_Description | CHAR(60) | NULL | No |
| Process_Control_Data | Application_ID | CHAR(12) | NOT NULL | Yes |
| | Component_ID | CHAR(12) | NOT NULL | Yes |
| | Request_ID | CHAR(12) | NOT NULL | Yes |
| | Schedule_ID | CHAR(12) | NOT NULL | Yes |
| | Control_Data | VARCHAR(2000) | NULL | No |
| Processing_Component_{—} | Application_ID | CHAR(12) | NOT NULL | Yes |
| for_Request | Component_ID | CHAR(12) | NOT NULL | Yes |
| | Request_ID | CHAR(12) | NOT NULL | Yes |
| | Schedule_ID | CHAR(12) | NOT NULL | Yes |
| | Attempt_Number | INTEGER | NULL | No |
| | Status_Code_ID | CHAR(12) | NOT NULL | No |
| Restart_Parameters | Restart_Parameter_ID | CHAR(12) | NOT NULL | Yes |
| | Restart Parameter_{—} | CHAR(60) | NULL | No |
| | Description | | | |
| Schedule | Schedule_ID | CHAR(12) | NOT NULL | Yes |
| | Schedule_Description | CHAR(60) | NULL | No |
| | Schedule_Time | DATETIME | NULL | No |
| Status_Codes | Component_ID | CHAR(12) | NOT NULL | Yes |
| | Status_Code_ID | CHAR(12) | NOT NULL | Yes |
| | Status Code_Description | VARCHAR(255) | NULL | No |
| Transaction_Input_Data | Application_ID | CHAR(12) | NOT NULL | Yes |
| | Request_ID | CHAR(12) | NOT NULL | Yes |
| | Sequence | INTEGER | NOT NULL | Yes |
| | Input_Data | VARCHAR(2000) | NULL | No |
| Transaction_Request | Application_ID | CHAR(12) | NOT NULL | Yes |
| | Request_ID | CHAR(12) | NOT NULL | Yes |

DB2XXXXXX.IFS_QU

| COLNAME | COLNO | TYPENAME | LENTGTH | NULLS |
|---|---|---|---|---|
| QU_QU_SYS_ID | | INT | | NOT NULL |
| QU_IF_NM | | CHAR | 80 | NOT NULL |
| QU_STEP_COMP | | INT | | NOT NULL WITH DEFAULT 0 |
| QU_ST | | CHAR | 1 | NOT NULL WITH DEFAULT ‘ERROR’ |
| QU_CR_TS | | TIMESTAMP | | NOT NULL WITH DEFAULT |
| QU_PRTY | | INT | | NOT NULL WITH DEFAULT 9 |
| QU_ALT_IF | | CHAR | 10 | NOT NULL WITH DEFAULT ‘PRIMARY’ |
| QU_PID_LOCK | | INT | | NOT NULL WITH DEFAULT 0 |

Unique index: QU_QU_SYS_ID

| Column | Name | Description |
|---|---|---|
| QU_QU_SYS_ID | Queue Id | Primary Key - system key that identifies the request in the |
| | | queue |
| QU_IF_NM | Interface name | Interface name identifies which interface has to take care |
| | | of the query. |
| QU_STEP_COMP | Step completed | An interface consists of different steps. QU_STEP_COMP |
| | | parameter tells which step in the component chain that was |
| | | last completed. STEP_COMP is set to zero by default. |
| QU_ST | Status | A component has a number of attempts to complete its work. |
| | | Every time a component fails, the QU_COMP_ATM field in |
| | | IFS_QU_COMP is increased with one. If IFS_COMP_QU |
| | | reaches the maximum of allowed attempts the Status is |
| | | changed to Error and the request will not be processed |
| | | anymore. |
| QU_CR_TS | Time stamp | Timestamp representing the point in time when the request |
| | | was set into the queue (Initially set by the queue API, |
| | | changed every time a component writes into the queue). |
| QU_PRTY | Priority | Set the priority of request. |
| QU_ALT_IF | Alternative interface | Control field for alternative interfaces |
| QU_PID_LOCK | Lock | When processing a request the component sets its Process-id |
| | | in the lock field end thereby locks the row. |

DB2XXXXXX.IFS_QU_COMP

| COLNAME | COLNO | TYPENAME | LENTGTH | NULLS |
|---|---|---|---|---|
| QU_COMP_{—} | | INT | | NOT NULL |
| QU_SYS_ID | | | | |
| QU_COMP_STEP_NR | | INT | | NOT NULL |
| QU_COMP_ATM_NR | | INT | | NOT NULL WITH DEFAULT 0 |
| QU_COMP_USR_INFO | | VARCHAR | 255 | |
| QU_COMP_CTL_DATA | | CHAR | 80 | |

Unique index: QU_COMP_QU_SYS_ID, QU_COMP_STEP_NR

| COLNAME | Name | Description |
|---|---|---|
| QU_COMP_QU_SYS_ID | Queue | Primary Key—system key |
| | system id | that identifies the request |
| | | in the queue. |
| QU_COMP_STEP_NR | Step number | Tells which step in the |
| | | component chain the |
| | | request is for. |
| QU_COMP_ATM_NR | Attempts | Every time a component |
| | | fails the attempt field is |
| | | increased with one |
| QU_COMP_USR_INFO | User | User specific information. |
| | information | E.g. username and |
| | | password for a |
| | | ftp-transaction |
| QU_COMP_CTL_DATA | Control data | Control data for e.g. how |
| | | much has been processed |
| | | by a component before it |
| | | failed. |

DB2XXXXXX.IFS_QU_DATA

| COLNAME | COLNO | TYPENAME | LENTGTH | NULLS |
|---|---|---|---|---|
| QU_DATA_{—} | | INT | | NOT NULL |
| QU_SYS_ID | | | | |
| QU_DATA_{—} | | INT | | NOT NULL |
| STEP_NR | | | | |
| QU_DATA_{—} | | INT | | NOT NULL |
| SEQ_NR | | | | |
| QU_DATA_{—} | | VARCHAR | 2000 | NOT NULL |
| DATA | | | | |

Unique index: QU_DATA_QU_SYS_ID, QU_DATA_STEP_NR, QU_DATA_SEQ_NR

| COLNAME | Name | Description |
|---|---|---|
| QU_DATA_QU_SYS_ID | Queue | Primary Key—system key |
| | system id | that identifies the request in |
| | | the queue. |
| QU_DATA_STEP_NR | Step number | Tells which step in the |
| | | component chain the data |
| | | is for. |
| QU_DATA_SEQ | Sequence | Data can be spread over |
| | | several rows. Sequence |
| | | indicates the sequence of |
| | | the data. |
| QU_DATA_DATA | Data | Data for the component |

DB2XXXXXX.IFS_IF_CFG_DATA

| COLNAME | COLNO | TYPENAME | LENTGTH | NULLS |
|---|---|---|---|---|
| CFG_DATA_{—} | | CHAR | 80 | NOT NULL |
| IF_NAME | | | | |
| CFG_DATA_{—} | | INT | | NOT NULL |
| STEP_NR | | | | |
| CFG_DATA_{—} | | VARCHAR | 255 | NOT NULL |
| PATH | | | | |
| CFG_DATA_{—} | | VARCHAR | 80 | NULL |
| PRM | | | | |
| CFG_DATA_{—} | | INT | | NULL |
| PRC_TMO | | | | |

Unique index: CFG_DATA_IF_NAME, CFG_DATA_STEP_NR

| COLNAME | Name | Description |
|---|---|---|
| CFG_DATA_IF_NAME | Interface | Interface key. |
| | name | |
| CFG_DATA_STEP_NR | Step number | Key indicating what number |
| | | the component is in the |
| | | component chain. |
| CFG_DATA_PATH | Path | Path to the component |
| CFG_DATA_PTM | Parameter | Parameter for the component |
| CFG_DATA_PRC_TMO | Process | Indicates for how long a |
| | timeout | component may run before the |
| | | operator is alarmed. |

DB2XXXXXX.IFS_LOG

| COLNAME | COLNO | TYPENAME | LENTGTH | NULLS |
|---|---|---|---|---|
| LOG_LOG_{—} | | INT | | NOT NULL |
| SYS_ID | | | | |
| LOG_LHD | | INT | | NOT NULL |
| LOG_TS | | TIMESTAMP | | NOT NULL |
| | | | | WITH |
| | | | | DEFAULT |
| LOG_DEL | | CHAR | 1 | NOT NULL |
| | | | | WITH |
| | | | | DEFAULT |
| | | | | ‘y’ |
| LOG_TX | | VARCHAR | 255 | NOT NULL |

Unique index: LOG_LOG_SYS_ID

| COLNAME | Name | Description |
|---|---|---|
| LOG_LOG_SYS_ID | Log id | Primary Key—system key. |
| LOG_LHD | Log | Log identifier |
| | header | |
| LOG_TS | Time | Timestamp representing the point |
| | stamp | in time when the log was recorded |
| LOG_DEL | Log | House keeping flag. If the flag is |
| | delete | set to one the log line may not be |
| | | deleted |
| LOG_TXT | Log text | |

Character Codes:

| | |
|---|---|
| IFS | INTERFACE SERVER |
| QU | QUEUE |
| IF | INTERFACE |
| COMP | COMPLETED |
| ALT | ALTERNATIVE |
| ATM | ATTEMTS |
| CFG | CONFIGURATION |
| INFO | INFORMATION |
| PRM | PARAMETER |

Figures for Process Documentation

Some figures to illustrated some of main processes in the Interface Server.

Process flow for the Interface Server is illustrated in FIG. 31

Resource Handling by the Interface Server

FIGS. 32 and 33 shows to possible ways of handling resources (in order to avoid conflicting requests and tasks for the Interface Server, notice the operation sequence).

1. A method of configuring a generic transaction server, comprising a transaction kernel being specific for the server and has a plurality of configured services assigned, such as linked to the transaction kernel, said generic transaction server being useful for performing transactions on a computer system, said method comprising the steps of:
selecting and/or adding a number of services, said selection being preferably based on a business model, each service being adapted to communicate with a transaction kernel by keyword/value pairs; each keyword/value pairs is either input, output and/or internal;
configuring some or all of the services selected, said configuration being preferably performed in such a manner so that the configured services are reflecting the business model;
if necessary or desired generating a business configuration database defining the configured services related to the business model; and
building a transaction kernel of the generic transaction server, said transaction kernel being adapted to inserting, hashing and fetching keyword/value pairs from and routing keyword/value pairs between services linked to the transaction kernel, said inserting, fetching and routing being instantiated by receipt of a transactions string.

2. A method according to claim 1, wherein said inserting, fetching and routing performed by the transaction kernel is(are) being instantiated by receipt of a transaction string.

3. A method according to claim 1, wherein the services are assigned, such as linked, to the transaction kernel by inherent characteristics and/or features of the services, so establishment of pronounced links between the services and the transaction kernel is not present.

4. A method according to claim 3, wherein generation of the transaction kernel is performed in such a manner that said inherent characteristics of the services is considered during generation so as to establish the inherent links between the transaction kernel and the services.

5. A method according to claim 3, wherein said inherent characteristics and/or features are provided by generation of a hashing formation, such as a vector, matrix or the like,.

6. A method according to claim 1, wherein one or more of the selected services is(are) pre-configured and wherein only those selected services not being pre-configured are configured.

7. A method according to claim 1, wherein some or all of the selected services are selected from a pre-developed plurality of services, such as services configured to tax calculation, credit card clearance and connections.

8. A method according to claim 1, further comprising the process of generating one or more service.

9. A method according to claim 1, further comprising the step of consulting an interface server when configuring a service.

10. A method according to claim 1, further comprising the step of generating a single server entry point where all or substantial all communication to and from the transaction kernel goes through.

11. A method according to claim 1, which method further comprising the step of building a hashing formation, such as a vector, matrix or the like, for parsing a data string, preferably being character based, comprising at least one keyword/value pair, which method comprises
providing a predefined hashing formation, such as a vector, matrix or the like, in which each predefined combination of a selection of characters is represented by a unique element, said selection of characters being preferably all those characters or substantially all those characters being allowed to figure in said keywords; and
for each keyword to be supported by the kernel, assigning a first pointer to the element representing the combination of characters representing the keyword in question, which first pointer is pointing to said keyword.

12. A method according to claim 1, which method further comprising the steps of building a separate hashing formation, such as a vector, matrix or the like, for parsing reserved keyword/value pair, said reserved keyword/values pairs stipulates for instance services to be requested, priority of execution service, host on which the service is to be executed etc.

13. A generic transaction server comprising a transaction kernel having a plurality of configured services assigned, such as linked, wherein
said services communicates with the transaction kernel by keyword/value pairs; each keyword/value pair is either input, output or internal;
said transaction kernel being adapted to inserting and fetching keywords from services assigned, such as linked, to the transaction kernel and wherein
communication to and from the transaction kernel is provided by a Server entry point.

14. A generic transaction server according to claim 13, wherein said transaction kernel further is adapted to routing keywords between said services.

15. A generic transaction server according to claim 13, wherein a service entity corresponding to said services is defined by one or more attributes, such as service identifier, code for routing to the service, description of the service and/or state attribute.

16. A generic transaction server according to claim 13, wherein a keyword entity corresponding to said keyword/value pairs is defined by a number of attributes, such as keyword identifier, keyword code and/or keyword description.

17. A generic transaction server according to claim 13, wherein a relation between a keyword/value pair and a service is defined as attributes, said attributes being preferably defined within the framework of entities (keyword in service entities).

18. A generic transaction server according to claim 13, wherein the relation between keyword/value pair and service also links between services.

19. A generic transaction server according to claim 13, further comprising a transaction main module and/or an encryption module and/or database API and/or.

20. A generic transaction server according to claim 13, wherein all or substantial all communication to and from the transaction kernel goes through a single Server entry point.

21. A generic transaction server according to claim 13, wherein said inserting, fetching and routing performed by the transaction kernel is(are) being instantiated by receipt of a transaction string.

22. A generic transaction server according to claim 13, wherein a request for a service is initiated by the generic transaction server.

23. A generic transaction server according to claim 13, wherein the services are assigned, such as linked, to the transaction kernel by inherent characteristics and/or features of the services, so establishment of pronounced links between the services and the transaction kernel is not present.

24. A generic transaction server according to claim 13, said transaction system utilizes a transaction data model comprising a service entity, a keyword entity, keyword in service entities and a section entity.

25. A transaction system according to claim 24, in which a section entity groups a number of keywords and/or comprises multiple values on keywords.

26. A generic transaction server according to claim 13, said generic transaction server further comprising a hashing formation, such as a vector, matrix or the like, for parsing elements of a data string, preferably being character based, comprising at least one keyword/value pair, said hashing formation comprises
a plurality of pointers to pointers entities; wherein each of the pointer to pointer entities comprises a first pointer pointing at either directly or indirectly at least one second pointer configurable to pointing at at least one of the elements of the data string or being null-terminated, such as pointing at a null-pointer;
Preferably, an element may be a keyword, a value and/or a keyword/value pair comprised in the data string. and
an entry to each first pointer.

27. A generic transaction server according to claim 26, wherein each entry to each first pointer is indexed and accessible by a selected number of characters of the keyword corresponding to second pointer.

28. A generic transaction server according to claim 27, wherein the selected numbers of characters are the first and the last character of said keyword corresponding to said second pointer.

29. A generic transaction server according to claim 27, wherein, in case the first pointer points at more than one second pointer, said second pointers being arranged in an array further comprising information indicating the number of second pointers comprised in the array.

30. A generic transaction server according to claim 26, wherein said hashing formation supports use of section entities by use of section markers.

31. A generic transaction server according to claim 26, said generic transaction server comprises a separate hashing formation for parsing reserved keyword/value pair, said reserved keyword/values pairs stipulates for instance services to be requested, priority of execution service, host on which the service is to be executed etc.

32. A generic transaction server according to claim 31, wherein said separate hashing formation comprises entries, wherein each entry corresponds to a reserved keyword and wherein each entry having assigned to it a pointer pointing at the functionality corresponding to said reserved keyword.

33. A computer system comprising a transaction server according to claim 13 and an interface server supporting asynchronous to synchronous transactions sequences of the computer system, the interface server comprises
a set of interface functions for accessing services being external to the transaction server,
one or more connections each connecting a service of the transaction server to the interface server enabling data communication from services of the transaction server and to the interface server, and
a connection between one or more of the interface server's interfaces and a Server entry point of the transaction server.

34. A computer system according to claim 33, further comprising a scheduler for controlling accessing of the services being external to the transaction server.

35. A computer system according to claim 33, further comprising storage means for storing and retrieving data to be processed by the one or more external services, and wherein one or more of the interface functions being adapted to store and retrieve data to be processed by the one or more external services.

36. A platform for performing e-commerce transactions, said platform comprises a generic transaction server according to any of the claim 13.

37. A platform for performing e-commerce transaction, said platform comprises a computer system according to claim 33.

38. A computer system comprising processor means and storage means for carrying out the method according to claim 1.
